(19) United States
(12) Patent Application Publication
(10) Pub. No.: US 2025/0086398 A1
(43) Pub. Date: Mar. 13, 2025

(54) GENERATING AND USING INTENT TAXONOMIES TO IDENTIFY USER INTENT

(71) Applicant: Microsoft Technology Licensing, LLC, Redmond, WA (US)

(72) Inventors: Longqi YANG, Issaquah, WA (US); Chirag Shah, Kenmore, WA (US); Mengting Wan, Bellevue, WA (US); Jennifer Lynay Neville, West Lafayette, IN (US); Tara Lynn Safavi, Seattle, WA (US); Scott Joseph Counts, Seattle, WA (US); Siddharth Suri, Redmond, WA (US); Ryen William White, Woodinville, WA (US); Reid Marlow Andersen, Los Angeles, CA (US); Georg Ludwig Wilhelm Buscher, San Jose, CA (US); Sathish Kumar Manivannan, Redmond, WA (US); Leijie Wang, Seattle, WA (US); Sarkar Snigdha Sarathi Das, Redmond, WA (US); Ali Montazeralghaem, Amherst, MA (US)

(21) Appl. No.: 18/465,742

(22) Filed: Sep. 12, 2023

(51) Int. Cl. G06F 40/35; G06F 40/169; G06F 40/40; G06N 20/00

(52) U.S. Cl. CPC G06F 40/35; G06F 40/169; G06F 40/40; G06N 20/00

(57) ABSTRACT

Methods, computer systems, computer-storage media, and graphical user interfaces are provided for efficiently generating and using intent taxonomies. In embodiments, training data, including data requests for information, is obtained. Thereafter, a model prompt to be input into a large language model is generated. The model prompt includes an instruction to generate an intent taxonomy, an indication of the training data to use for generating the intent taxonomy, and a taxonomy attribute desired to be used as criteria to generate a quality intent taxonomy. An intent taxonomy that includes user intent classes is obtained as output from the large language model. The intent taxonomy is analyzed to determine whether the intent taxonomy is valid. When the intent taxonomy is determined as valid, the intent taxonomy is provided for use in identifying user intent, and when the intent taxonomy is determined as invalid, the intent taxonomy is refined.

### BACKGROUND

Identifying and understanding user intent associated with requests for information can be valuable. As one example, understanding such a user intent can enable providing the most relevant and meaningful results. However, identifying user intent from log data can be difficult. For instance, user intents can be fluid, making it difficult to identify user intent. In particular, in the case of emerging modalities, a user's understanding, usage, and behaviors rapidly evolve, thereby resulting in dynamically changing user intents. As another example, log data may lack context to accurately identify user intent.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, facilitating efficient generation and utilization of intent taxonomies. In this regard, intent taxonomies are efficiently and effectively generated in an automated approach (e.g., using a large language models (LLM)), such that the intent taxonomies may be used in an accurate manner. Generating an intent taxonomy in a way that validates the intent taxonomy results in a quality intent taxonomy that can be used to accurately identify user intents for subsequent data requests. In embodiments, a LLM is used to identify user intents. As one example, a generated intent taxonomy and a data request is provided as input to a LLM to identify a user intent class associated with the data request. The user intent class can then be analyzed or presented for display. For example, in some cases, the user intent class can be used to provide a recommendation or information relevant to a user providing the data request for which the user intent is identified.

### BRIEF DESCRIPTION OF THE DRAWINGS

The technology described herein is described in detail below with reference to the attached drawing figures, wherein:

FIG. 1 is a block diagram of an exemplary system for facilitating efficient generation and utilization of intent taxonomies, suitable for use in implementing aspects of the technology described herein;

FIG. 2 is an example implementation for facilitating efficient generation and utilization of intent taxonomies, via an intent taxonomy manager, in accordance with aspects of the technology described herein;

FIG. 3 provides an example intent taxonomy, in accordance with embodiments of the present technology;

FIG. 4 provides one example implementation for generating and validating an intent taxonomy, in accordance with embodiments of the present technology;

FIG. 5 provides one example implementation for generating and using an intent taxonomy, in accordance with aspects of the technology described herein;

FIG. 6 provides a first example method for facilitating efficient generation and use of an intent taxonomy, in accordance with aspects of the technology described herein;

FIG. 7 provides a second example method for facilitating efficient generation and use of an intent taxonomy, in accordance with aspects of the technology described herein;

FIG. 8 provides a third example method for facilitating efficient generation and use of an intent taxonomy, in accordance with aspects of the technology described herein; and

FIG. 9 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Understanding the purpose or the task behind a user's request in an information access context, such as a search query or chat inquiry, can provide valuable information. For example, understanding such a user intent can enable providing the most relevant and meaningful results. Identifying user intent (e.g., from log data), however, can be difficult. For instance, user intents can be fluid, making it difficult to identify user intent. As another example, log data, from which user intents can be identified, may lack context to accurately identify user intent. Moreover, in the case of emerging modalities, such as AI-driven chat, a user's understanding, usage, and behaviors rapidly evolve, thereby necessitating on-demand, task-focused taxonomies.

In some conventional approaches, taxonomies are manually generated, which is a time consuming and tedious process, and often results in an ineffective taxonomy. In an effort to facilitate taxonomy generation, in some conventional implementations, coding and thematic analysis are used. Such approaches, however, are time-consuming and require human expertise. Other approaches including using quantitative methods such as metrics and statistics. These quantitative approaches, however, often do not capture nuances and diversity of user intents. In such conventional implementations, in addition to the time consumed to generate a taxonomy related to user intent, computing resources are unnecessarily consumed. For instance, feedback loops to refine a taxonomy to accommodate numerous and diverse user intents can unnecessarily consumes computing resources.

Accordingly, embodiments of the present technology are directed to efficiently and effectively generating and using intent taxonomies. In this regard, intent taxonomies are efficiently and effectively generated in an automated manner such that intent taxonomies may be presented or used to identify user intent. Generating an intent taxonomy in an automated manner utilizing a large language model reduces computing resources utilized to otherwise generate an intent taxonomy. For example, intent taxonomy generation described herein approaches the taxonomy generation accounting for assessing validity of the intent taxonomy, such that a reliable, accurate, and quality intent taxonomy is generated. In particular, the intent taxonomy can be generated in accordance with various criteria to assess quality, such as comprehensiveness, consistency, clarity, accuracy, and conciseness. In this way, computing resources used to analyze and adjust intent taxonomies are not unnecessarily used. Further, using a quality intent taxonomy to identify user intent, for example, associated with a data request, facilitates a more accurate and beneficial response or information provided to a user(s). For instance, assume a user provides a search query or chat inquiry and user intent associated therewith is accurately identified. In such a case, a relevant response or recommendation can be provided to the user, thereby reducing the additional computing resources that may be consumed by the user to otherwise seek out the information or that may be consumed by the user for being provided with undesired information.

In operation, to efficiently and effectively generate an intent taxonomy, a machine learning model is used. As described in association with embodiments described herein, a machine learning model used to generate intent taxonomies in an automated manner may be in the form of an LLM. In this regard, aspects of the technology described herein facilitate generating a model prompt to input into the machine learning model to attain a desired output in the form of an intent taxonomy. For example, a model prompt can be programmatically generated and used to facilitate output in the form of an intent taxonomy. The model prompt may be based on training data (e.g., previous data requests, data responses, user interactions, and/or the like). In addition, the model prompt may include taxonomy structure data indicating a target or desired taxonomy structure to be generated and/or desired taxonomy attributes indicating quality criteria desired to be taken into account in generating the intent taxonomy. Using technology described herein, an intent taxonomy can be generated to be comprehensive, consistent, clear, accurate, and concise such that it can be effectively used to identify user intents. Various implementations can be used to validate and/or test an intent taxonomy such that quality taxonomy results. As described herein, in some cases, human assessors can facilitate such a validation process. A combination of machine and human analysis can facilitate an approach that reduces effort and increases coverage. Further, such an approach can facilitate reliability as a meaningful understanding of the approaches used by large language models may be unknown.

In accordance with generating a quality or validated intent taxonomy, the intent taxonomy can be used to identify user intent. In this regard, the intent taxonomy can be used to identify user intent associated with one or more data requests or data associated therewith. As described, one approach includes generating a model prompt that includes the intent taxonomy as well as the data request, and/or data associated therewith. A large language model can then process the model prompt and output a user intent class or label associated with each data request. The user intent class can then be analyzed or presented for display. As described, in some cases, the user intent class can be used to provide a recommendation or information relevant to a user providing the data request for which the user intent is identified.

Advantageously, using an LLM to generate and/or use intent taxonomies facilitates reducing computing resource consumption, such as computer memory and latency. In particular, intent taxonomies can be accurately generated without requiring training and/or fine-tuning of the model for the particular taxonomy or for a particular model output. Utilizing pre-trained models reduces computing resources consumed for performing training.

### Overview of Exemplary Environments for Generating and Using Intent Taxonomies to Identify User Intent

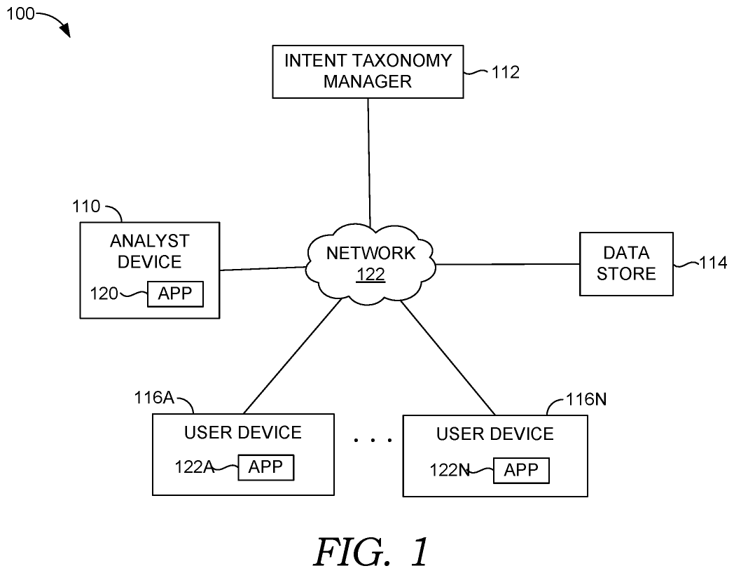

Referring initially to FIG. 1, a block diagram of an exemplary network environment 100 suitable for use in implementing embodiments described herein is shown. Generally, the system 100 illustrates an environment suitable for facilitating efficient generation and utilization of intent taxonomies to identify user intent. Among other things, embodiments described herein efficiently generate an intent taxonomy and, thereafter, use the intent taxonomy to identify user intent, for example, associated with a data request (e.g., a search query or chat inquiry). Generally, an intent taxonomy refers to a taxonomy representing various user intent classes or categories. For example, an intent taxonomy may include various user intent classes, such as information retrieval, problem solving, learning, content creation, and leisure. An intent taxonomy may include any number of levels or layers in a hierarchical structure. In accordance with generating an intent taxonomy, the intent taxonomy can be used to determine user intent associated with a data request or a set of data requests. For instance, as a user inputs a data request, such as a search query or chat inquiry, the intent taxonomy can be used to determine a user intent associated with the data request.

The network environment 100 includes analyst device 110, an intent taxonomy manager 112, a data store 114, and user devices 116a-116n (referred to generally as user device(s) 116). The analyst device 110, the intent taxonomy manager 112, the data store 114, and the user devices 116a-116n can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document. Neither should the exemplary network environment 100 be interpreted as having any dependency or requirement related to any single component or combination of components illustrated therein. For example, the analyst device 110 and user devices 116a-116n may be in communication with the intent taxonomy manager 112 via a mobile network or the Internet, and the intent taxonomy manager 112 may be in communication with data store 114 via a local area network. Further, although the environment 100 is illustrated with a network, one or more of the components may directly communicate with one another, for example, via HDMI (high-definition multimedia interface), and DVI (digital visual interface). Alternatively, one or more components may be integrated with one another. For example, at least a portion of the intent taxonomy manager 112 and/or data store 114 may be integrated with the analyst device 110 and/or user devices 116. For instance, a portion of the intent taxonomy manager 112 may be integrated with an analyst device, while another portion of the intent taxonomy manager 112 may be integrated with a user device 116.

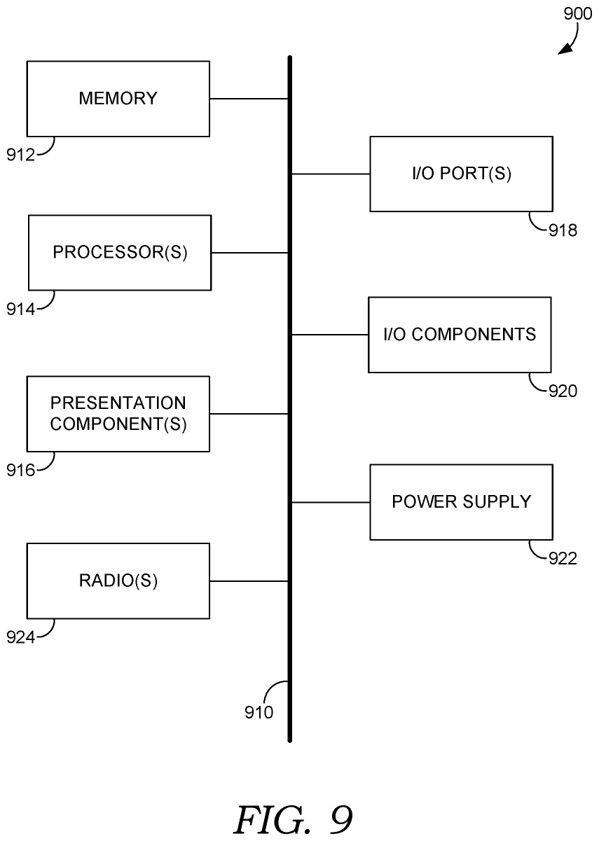

The analyst device 110 and/or user device 116 can be any kind of computing device capable of facilitating generating and/or using intent taxonomies. For example, in an embodiment, the analyst device 110 and user device 118 can be a computing device, such as computing device 900, as described above with reference to FIG. 9. In embodiments, the analyst device 110 and/or user device 116 can be a personal computer (PC), a laptop computer, a workstation, a mobile computing device, a PDA, a cell phone, or the like.

The analyst device 110, the intent taxonomy manager 112, and/or the user device 116 can include one or more processors, and one or more computer-readable media. The computer-readable media may include computer-readable instructions executable by the one or more processors. The instructions may be embodied by one or more applications, such as application 120 and application 122A-122N shown in FIG. 1. The application(s) may generally be any application capable of facilitating generating and/or using intent taxonomies. In some implementations, the application(s) comprises a web application, which can run in a web browser, and could be hosted at least partially server-side (e.g., via a server). In addition, or instead, the application(s) can comprise a dedicated application. In some cases, the application is integrated into the operating system (e.g., as a service).

Analyst device 110 and user device 116 can be client devices on a client-side of operating environment 100, while intent taxonomy manager 112 can be on a server-side of operating environment 100. Intent taxonomy manager 112 may comprise server-side software designed to work in conjunction with client-side software on analyst device 110 and/or user device 116 so as to implement any combination of the features and functionalities discussed in the present disclosure. An example of such client-side software is application 120 on analyst device 110 and application 122A on user device 116. This division of operating environment 100 is provided to illustrate one example of a suitable environment, and it is noted there is no requirement for each implementation that any combination of analyst device 110, intent taxonomy manager 112, and/or user device 116 to remain as separate entities.

In an embodiment, the analyst device 110 and/or user device 116 is separate and distinct from the intent taxonomy manager 112 and the data store 114 illustrated in FIG. 1. In another embodiment, the analyst device 110 and/or user device 116 is integrated with one or more illustrated components. For instance, the analyst device 110 may incorporate functionality described in relation to the intent taxonomy manager 112. For clarity of explanation, embodiments are described herein in which the analyst device 110, the intent taxonomy manager 112, the data store 114, and the user devices 116 are separate, while understanding that this may not be the case in various configurations contemplated.

As described, an analyst device, such as analyst device 110, facilitates generating and/or using intent taxonomies. An intent taxonomy can include any number of user intent classes. As described herein, a user intent class refers to a class or category of user intent, for example, associated with data requests (e.g., search queries and/or chat inquiries). An intent taxonomy is generally provided in the form of text, but other types of data may additionally or alternatively be used to provide an intent taxonomy and/or user intent classes associated therewith.

An analyst device 110, as described herein, is generally operated by an analyst, such as an individual or entity, that initiates generation and/or using of an intent taxonomy(s). In some cases, such an individual may be a contributor or programmer of code, a product designer, a website designer, an application designer, a marketer, an analyst associated with search engine or chat engine, and/or the like. In this regard, the analyst may be interested in intent taxonomies and/or user intents, for example, to understand data and trends, to identify responses or recommendations to provide, and/or the like.

In some cases, generation of an intent taxonomy(s) may be initiated at the analyst device 110. For example, in some cases, an analyst may directly or expressly select to generate or view an intent taxonomy(s). For instance, an analyst desiring to create or view an intent taxonomy may specify a desire to generate or view an intent taxonomy. To this end, an analyst of the analyst device 110 that initiates generating and/or providing of an intent taxonomy(s) may be an analyst that performs some aspect of product development, marketing, analysis or the like. In other cases, an analyst may indirectly or implicitly select to generate or view an intent taxonomy(s). For instance, an analyst may navigate to an application or website associated with user intent analysis. Based on the navigation to the application or website, the analyst may indirectly indicate to generate or view an intent taxonomy.

Generating and/or providing intent taxonomies may be initiated and/or presented via an application 120 operating on the analyst device 110. In this regard, the analyst device 110, via an application 120, might allow an analyst to initiate generation or presentation of an intent taxonomy(s). The analyst device 110 can include any type of application and may be a stand-alone application, a mobile application, a web application, or the like. In some cases, the functionality described herein may be integrated directly with an application or may be an add-on, or plug-in, to an application. One example of an application that may be used to initiate and/or present intent taxonomies includes any application in communication with or associated with a search service and/or a chat service. For example, a data analysis service associated with a search service and/or chat service may be operated via an application 120 to facilitate generation of intent taxonomies. A search service generally refers to a service or engine that performs search services. In particular, the search service receives search queries and, in response, provides search results relevant to the search queries. A chat service generally refers to a service or engine that performs AI chat services. In particular, the chat service receives chat inquiries and, in response, provides chat responses relative to the chat inquiries. In embodiments, a chat service uses a LLM(s) to generate the chat responses relative to the chat inquiries.

Although embodiments described above generally include an analyst or individual inputting or selecting (either expressly or implicitly) to initiate or view intent taxonomies, as described below, such initiation may occur in connection with search service, a chat service, and/or the like. For example, a search service or chat service may initiate generation of an intent taxonomy on a periodic basis. Such an intent taxonomy(s) can then be stored and, thereafter, accessed (e.g., by the search service or chat service) to provide for viewing and/or utilization (e.g., to identify user intent associated with a data request).

The analyst device 110 can communicate with the intent taxonomy manager 112 to initiate generation of an intent taxonomy(s) and/or obtain an intent taxonomy(s). In embodiments, for example, an analyst may utilize the analyze device 110 to initiate generation of intent taxonomies via the network 122. For instance, in some embodiments, the network 122 might be the Internet, and the analyst device 110 interacts with the intent taxonomy manager 112 (e.g., directly or via another service such as a search service or chat service) to initiate generation of intent taxonomies. In other embodiments, for example, the network 122 might be an enterprise network associated with an organization. It should be apparent to those having skill in the relevant arts that any number of other implementation scenarios may be possible as well.

In addition to initiating generation of an intent taxonomy, in some embodiments, the analyst device 110 can communicate additional taxonomy generation data. Taxonomy generation data generally refers to any data used to generate an intent taxonomy. Taxonomy generation data may include, for example, a set of training data (e.g., search and/or chat logs), or an indication thereof, taxonomy structure data, taxonomy attributes, etc. Training data is used for learning or generating an intent taxonomy. Taxonomy structure data includes data indicating a taxonomy structure desired for output. Taxonomy attributes refers to attributes used to form, enhance, or validate an intent taxonomy.

With continued reference to FIG. 1, the intent taxonomy manager 112 can be implemented as server systems, program modules, virtual machines, components of a server or servers, networks, and the like. As can be appreciated, in some cases, the intent taxonomy manager 112 may be a part of, or integrated with, a search or chat service. In this regard, the intent taxonomy manager 112 may function as portion of a search and/or chat service. In other cases, the intent taxonomy manager 112 may be independent of, and separate from, a search or chat service. Any number of configurations may be used to implement aspects of embodiments described herein.

In one aspect, the intent taxonomy manager 112 manages generation of intent taxonomies. In particular, the intent taxonomy manager 112 can obtain various training data, such as search logs and/or chat logs. Using the training data, the intent taxonomy manager 112 can generate a model prompt to initiate generation of an intent taxonomy. As one example, a model prompt may include various search queries and corresponding responses or various chat inquiries and corresponding responses. As can be appreciated, the model prompt may include additional data, such as taxonomy structure data, taxonomy attributes, and/or the like. The model prompt can be input into an LLM to obtain, as output, an intent taxonomy generated in association with the training data. Such training data used as a basis for generating an intent taxonomy may include search logs and/or chat logs based on data requests submitted via user devices 116. User devices 116a-116n may be any type of computing devices at which a user (e.g., of a search service or chat service) may provide a data request(s), such as a search query or chat inquiry. In some cases, the user device 116 may be used by a user, or individual, that provides data requests which are used as training data. Alternatively or additionally, the user device 116 may be used by a user that provides a data request for which user intent is desired to be determined. In response to the data requests, a search or chat service generally provides responses or results corresponding with the data request. Such responses or results are returned to the requesting user device for display to the user. In some cases, the users interact with the data requests and/or responses or results (e.g., select a response or result for viewing, modify the data request based on the returned results, etc.). The data requests provided via user devices 116 and/or the responses or interactions associated therewith may be provided to a search and/or chat service and stored in search and/or chat logs (e.g., via data store 114).

In embodiments, the intent summary manager 112 facilitates fine-tuning and/or validation of the intent taxonomy. In this way, an initially generated intent taxonomy can be updated or revised until an adequate or desired intent taxonomy is generated.

In accordance with generating an intent taxonomy, the intent taxonomy manager 112 outputs the intent taxonomy. In some cases, the intent taxonomy manager 112 outputs an intent taxonomy(s) to the analyst device 110. For example, assume an analyst intends to view or analyze an intent taxonomy via application 120 operating on analyst device 110. In such a case, the intent taxonomy may be provided to the analyst device 110. In other cases, the intent taxonomy manager 112 outputs an intent taxonomy(s) to another service, such as a search service or chat service, or a data store, such as data store 114. For example, upon generating an intent taxonomy, the intent taxonomy(s) can be provided to search or chat service and/or data store 114 for subsequent use (e.g., to identify user intent associated with a data request(s)).

In another aspect, upon generating an intent taxonomy, the intent taxonomy can be used to identify or determine user intent associated with a data request or a set of data requests. In this regard, the intent taxonomy manager 112 can obtain a request to identify a user intent associated with a data request(s) and, in response, provide a user intent(s) associated therewith. In doing so, the generated intent taxonomy is used to facilitate identification of a user intent(s) associated with a data request(s).

A request to identify user intent, also referred to herein as an intent identification request, can be provided in a number of ways and is not intended to be limited herein. As one example, an analyst device 110 may provide a request for intent identification. For instance, an analyst device 110 may provide or indicate a set of data requests, or conversations associated therewith, for which user intent is desired to be identified. As another example, a user device 116 may provide a request for intent identification. For instance, a user device 116 may provide a search query or chat inquiry for which a user intent is desired to be identified. In yet another example, a search service or chat service may provide a request for intent identification. For instance, a search or chat service may provide a request for intent identification in association with a batch of data requests, or conversations associated therewith. Alternatively or additionally, a search or chat service may provide a request for intent identification in association with a particular search query or chat inquiry for which a user intent is desired to be identified (e.g., in real time based on a search query or chat inquiry received via a user device 116).

In one embodiment, an LLM is used to identify user intent. In such cases, a model prompt can be generated. The model prompt may include various types of data, such as, the intent taxonomy and the data request(s) and/or response(s) thereto. The model prompt may be generated based on data obtained from the analyst device 110, the user device 116, the data store 114, or other service or server (e.g., a search service or chat service). Based on identifying user intent, such a user intent is provided, for example, to the analyst device 110, the user device 116, or other service, such as a search and/or chat service. Such identification of user intent can be analyzed and/or provided for display via a user interface.

Advantageously, utilizing implementations described herein enable generation and presentation of intent taxonomies to be performed in an efficient manner. Further, the intent taxonomies and determined user intents can dynamically adapt to align with more recent data requests provided by users. As such, an analyst and/or user can view desired and up-to-date information associated with a data request(s).

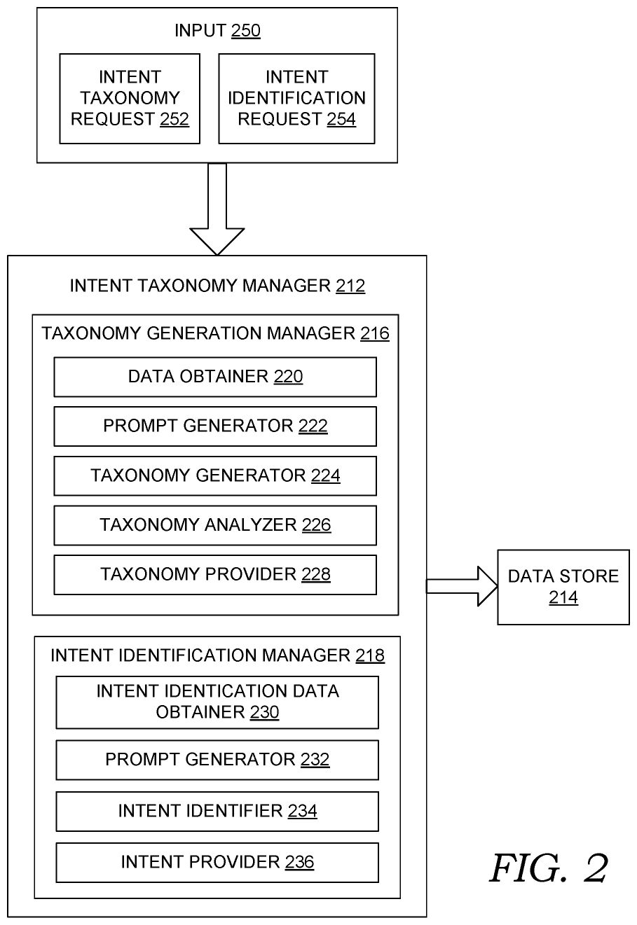

Turning now to FIG. 2, FIG. 2 illustrates an example implementation for generating and/or using intent taxonomies, via intent taxonomy manager 212. The intent taxonomy manager 212 can communicate with the data store 214. The data store 214 is configured to store various types of information accessible by the intent taxonomy manager 212 or other server. In embodiments, analyst devices (such as analyst device 110 of FIG. 1), user devices (such as user devices 116 of FIG. 1), intent taxonomy manager 212, and/or other servers or services (e.g., search service or chat service) can provide data to the data store 214 for storage, which may be retrieved or referenced by any such component. As such, the data store 214 may store logs (e.g., search logs and/or chat logs), training data, intent taxonomies, taxonomy structure data, taxonomy attributes, and/or the like. In this regard, data store 214 may store generated intent taxonomies, which can then be accessed for subsequent use or display.

In operation, the intent taxonomy manager 212 is generally configured to manage generation and/or utilization of intent taxonomies. In embodiments, the intent taxonomy manager 212 includes a taxonomy generation manager 216 and an intent identification manager 218. The taxonomy generation manager 216 is generally configured to generate an intent taxonomy that provides a taxonomy associated with user intents. The intent identification manager 218 is generally configured to use an intent taxonomy to identify user intent associated with a data request(s). According to embodiments described herein, the intent taxonomy manager 212 can include any number of other components not illustrated.

In embodiments, the taxonomy generation manager 216 includes a data obtainer 220, a prompt generator 222, a taxonomy generator 224, a taxonomy analyzer 226, and a taxonomy provider 228. According to embodiments described herein, the taxonomy generation manager 214 can include any number of other components not illustrated. In some embodiments, one or more of the illustrated components 220, 222, 224, 226, and 228 can be integrated into a single component or can be divided into a number of different components. Components 220, 222, 224, 226, and 228 can be implemented on any number of machines and can be integrated, as desired, with any number of other functionalities or services.

As described, the taxonomy generation manager 216 is generally configured to generate and/or provide an intent taxonomy. An intent taxonomy generally provides a scheme of classification related to user intent. In this regard, the intent taxonomy organizes user intents into classes, groups, or types. In some cases, an intent taxonomy may be in the form of a hierarchical classification. In such cases, any number of levels or layers may be used in the hierarchical structure. In other cases, an intent taxonomy may be in another form of classification (e.g., a single level or layer of classification). User intent generally refers to a primary purpose or goal a user has in mind when typing or inputting a search query or chat inquiry, for example, to a search engine or AI chat engine. Stated differently, user intent indicates an identification and/or categorization of what a user intended or desired to find when inputting a search query and/or chat inquiry. In some cases, user intent may be broader defined or more narrowly defined. In one embodiment, an intent taxonomy focuses on the user actions in a task and not the task objects. As such, the user intent taxonomy is different from a domain taxonomy which primarily describes the task objects.

The taxonomy generation manager 216 may receive input 250 to initiate generation and/or providing of an intent taxonomy(s). Input 250 may include an intent taxonomy request 252. An intent taxonomy request 252 generally includes a request or indication to generate an intent taxonomy. In some cases, an intent taxonomy request may specify, for example, an indication of a taxonomy structure that is desired, an indication of a set of training data to use for generating the intent taxonomy, an indication of desired taxonomy attributes, and/or the like, as described in more detail herein.

An intent taxonomy request 252 may be provided by any service or device. For example, in some cases, an intent taxonomy request 252 may be initiated and communicated via an analyst device, such as analyst device 110 of FIG. 1, or a search or chat service. For example, assume an analyst desires to generate a taxonomy for use in analyzing or determining user intent (e.g., via a website or application) associated with data requests (e.g., search queries or chat inquiries). In such a case, an intent taxonomy request 252 may be initiated that includes a request to generate an intent taxonomy. In one example, the intent taxonomy request 252 may specify or include a set of training data (e.g., including data requests and data responses) associated with the website(s) or application(s), such as a website or application having search functionality. In this regard, the intent taxonomy request 252 indicates or includes training data to use for generating an intent taxonomy.

An intent taxonomy request can be generated in any of a number of ways, including via an input or command, via selection of a link or button, and/or the like. Alternatively or additionally, an intent taxonomy request 252 may be automatically initiated and communicated to intent taxonomy manager 212. For example, a website or application service, such as search service or search analysis service, that uses an intent taxonomy(s) may automatically initiate intent taxonomy requests, for instance, based on a lapse of a time period, a reception of a set of training data (e.g., upon obtaining a predetermined number of new log data), or other criteria. As can be appreciated, the automated initiation of an intent taxonomy may be dynamic, for instance, based on attributes associated with training data. For example, in cases in which data requests are more frequently provided, an intent taxonomy may be initiated more frequently, whereas when data requests are less frequently provided, the intent taxonomy request may be initiated less frequently.

Although not illustrated, input 250 may include other information communicated in association with an intent taxonomy request 252. For example, and as described below as one implementation, taxonomy structure, training data, and/or taxonomy attributes, may be provided in association with the intent taxonomy request. For instance, in some cases, a user may provide an indication of a desired set of training data, taxonomy structure, and taxonomy attributes, which is communicated in association with an intent taxonomy request to initiate generation of an intent taxonomy.

The data obtainer 220 is generally configured to obtain data, such as training data, for use in generating an intent taxonomy(s). In this regard, in some cases, the data obtainer 220 obtains training data in accordance with obtaining an intent taxonomy request, such as intent taxonomy request 252. Training data generally refers to any data associated with a data request(s) and/or used to generate an intent taxonomy. In this regard, training data may include, but is not limited to, data requests, data responses, user interactions, data contexts, data weights, and/or the like. A data request generally refers to a request for data or information. In some cases, a data request is in the form of a search query (e.g., in association with a search engine). In other cases, a data request is in the form of a chat inquiry (e.g., in association with an AI-driven chat service). A data request can be in various forms, including direct input (e.g., text) provided by a user. As another example, a data request may be generated based on user actions such as result clicks. For example, assume a set of search results are presented to a user and a user selects one of the search results. In such a case, a data request can be generated that includes, for example, a title of the clicked result and/or a caption associated therewith. A data response generally refers to a response associated with a data request. In this way, a data response can be a response provided or identified for providing (e.g., to a user) in response to a data request. For example, a data response may be a search result or set of search results provided or to provide in response to a search query. As another example, a data response may be an answer provided or to provide in response to a chat inquiry. A user interaction generally refers to any interaction in association with a data response. For example, a user interaction may include selection or modification of a search result or data request. A data context generally refers to any context associated with a data request, data response, and/or user interaction. For example, data context may include a time, a frequency, a user device, and/or a user associated with a data request, data response, and/or user interaction. A data weight generally refers to a weight or scale associated with a particular data or set of data. For example, a data request and a corresponding response may correspond with one weight, while another data request and corresponding response may correspond with another weight (e.g., based on recency of data). As another example, a data request may correspond with one weight, while a corresponding data response may correspond with another weight. In some cases, weights can be defined based on consumer input (e.g., positive feedback, such as likes, or negative feedback, such as, dislikes, associated with a data request or data response). In some cases, training data may be in the form of conversations. A conversation, as used herein, refers to data associated with a particular data request. For example, a conversation may include a data request and a corresponding data response. As another example, a conversation may include a data request, a corresponding data response, and user interactions associated with the data request and/or data response. As can be appreciated, such training data can be in any of a number of formats, such as text, images, videos, audio, and/or the like.

The data obtainer 220 can receive or obtain training data from various sources for utilization in determining an intent taxonomy(s). As described above, in some cases, training data may be obtained as input 250 along with the intent taxonomy request 252. For example, in some implementations, an analyst (e.g., an administrator) may input or select training data, or a portion thereof, via a graphical user interface for use in generating an intent taxonomy. For instance, an analyst, operating via an analyst device, desiring to generate an intent taxonomy may select, indicate, or input a set of training data (e.g., data requests, data responses, user interactions, and/or conversations) for use in generating a corresponding intent taxonomy.

Additionally or alternatively, the data obtainer 220 may obtain data, such as training data, from any number of sources or data stores, such as data store 214. In this regard, in accordance with initiating generation of an intent taxonomy, the data obtainer 220 may communicate with a data store(s) or other data source(s) and obtain training data to generate an intent taxonomy(s). Such training data that may be obtained includes, for example, data requests, data responses, user interactions, data weights, data contexts, and/or the like. Data store 214 illustrated in FIG. 2 may include such training data, but any number of data stores and/or data sources may provide various types of training data. Such data stores and data sources may include public data, private data, and/or the like. For instance, a search service (e.g., website or application) may store log data associated with various searches, including search queries, search results, and/or user selections associated therewith. As another example, a chat service (e.g., website or application) may store log data associated with various AI-based chat requests, including chat inquiries, responses, and/or user interactions associated therewith.

In some cases, the data obtainer 220 may identify a type or extent of training data to obtain. For example, assume an intent taxonomy request 252 corresponds with an indication of a data log (e.g., associated with a particular search or chat service). For instance, a website service associated with a data log may provide an intent taxonomy request indicating the data log. Upon identifying the data log, the data obtainer 220 may obtain data requests and corresponding data responses from the data log. As another example, assume an intent taxonomy request 252 is provided. In such a case, the data obtainer 220 may obtain log data associated with a particular time frame. In some cases, the data obtainer 220 may obtain training data associated with a particular search or chat service identified in association with an analyst requesting an intent taxonomy.

The particular type of data obtained by the data obtainer 220 may vary depending on the particular configuration implemented. For example, in some cases, an intent taxonomy is desired to be generated for identifying user intent in association with search queries. In such cases, the training data obtained can be search training data, such as search queries and corresponding search results. In other cases, an intent taxonomy is desired to be generated for identifying user intent in association with chat inquiries. In such cases, the training data can be chat training data, such as chat inquiries and corresponding responses. In yet other cases, training data including both search data and chat data may be desired to generate an intent taxonomy.

In addition to training data, the data obtainer 220 can obtain other types of data. For instance, in some cases, taxonomy structure, taxonomy attributes, data weights, and/or data context are used in generating an intent taxonomy and, as such, are obtained by the data obtainer 220. The examples of types of data obtained by the data obtainer 220 are not intended to be restrictive. In this regard, the data obtainer 220 may obtain more or less, or different, types of training data. In some cases, such data may be included in an intent taxonomy request or obtained via a data store, among other ways. For instance, an analyst may provide a preferred taxonomy structure and attributes in association with the intent taxonomy request. As another example, in association with obtaining an intent taxonomy request 252, the data obtainer 220 may reference a preferred taxonomy structure and attributes from the data store 214 (e.g., based on the analyst initiating the request).

The data obtainer 220 may also obtain any amount of data, such as training data. For example, in some cases, an entire set of log data may be obtained. In other cases, only a portion of log data may be obtained. For example, a portion of log data (e.g., randomly assigned or based on an attribute such as a time) is used as training data. The type and amount of training data obtained by data obtainer 220 may vary per implementation and is not intended to limit the scope of embodiments described herein.

The prompt generator 222 is generally configured to generate model prompts. As used herein, a model prompt generally refers to an input, such as a text input, that can be provided to taxonomy generator 224, such as an LLM, to generate an output (e.g., in the form of an intent taxonomy). In embodiments, a model prompt generally includes text to influence a machine learning model, such as an LLM, to generate text having a desired content and structure. The model prompt typically includes text given to a machine learning model to be completed. In this regard, a model prompt generally includes instructions and, in some cases, examples of desired output. A model prompt may include any type of information. In accordance with embodiments described herein, a model prompt may include various types of data. In some aspects, a model prompt is generated to obtain, as output, an intent taxonomy. As such, the model prompt generally includes training data, such as data requests and corresponding responses (or conversations).

In embodiments, the prompt generator 222 is configured to select a set of training data for which to use to generate an intent taxonomy. For example, assume an intent taxonomy is to be generated for AI chat requests and a chat log is obtained. In such a case, the prompt generator 222 may select a set of chat inquiries and corresponding responses and/or user interactions to use in generating an intent taxonomy. In this way, after training data is obtained, the prompt generator 222 may select a specific set of training data from the obtained set of training data.

Training data may be selected based on any number or type of criteria. As one example, training data (e.g., requests and responses, or conversations) may be selected to be under a maximum number of tokens required by a taxonomy generator, such as an LLM. For example, assume an LLM includes a 3000 token limit. In such a case, training data totaling less than the 3000 token limit may be selected. Such training data selection may be based on, for example, recency of the data such that more recent training data is selected. In other cases, training data may be selected based on weights (e.g., highest weights, equal distribution of weights, or other criteria associated with a weight). For instance, training data may be selected based on a corresponding weight that is an indication of the helpfulness of the training data, for example, according to individuals who have reviewed the training data, based on attributes of users associated with the training data, etc.

As can be appreciated, in some cases, different portions of training data can be selected for inclusion in a particular prompt to generate an intent taxonomy. For example, assume a set of training data includes 1,000 conversation (e.g., including data requests and corresponding data responses). In such a case, a first set of 500 conversations may be selected for a first model prompt, a second set of 500 different conversations may be selected for a second model prompt, and each of the 1,000 conversations may be selected for a third model prompt. Using different portions of training data sets to generate different intent taxonomies enables a more robust analysis of the intent taxonomies.

In other cases, the prompt generator 222 utilizes the specific training data obtained via data obtainer 220. For example, in some cases, the training data obtainer 220 may obtain a particular set of training data (e.g., based on a user selection, based on an algorithm or rule, based on machine learning), and the prompt generator 222 uses such obtained training data.

In addition to the model prompt including training data, such as data requests, data responses, user interactions, and/or the like, a model prompt may also include output attributes. Output attributes generally indicate desired aspects associated with an output, such as an intent taxonomy. By way of example, output attributes may include taxonomy structure, taxonomy attributes, and/or the like. Taxonomy structure generally refers to a desired structure for outputting an intent taxonomy. In some cases, a taxonomy structure can be indicated or specified by a user, for example, via user device of FIG. 1. In other cases, a taxonomy structure may be a preferred default structure or a machine learned structured. A taxonomy structure can be identified in any of a number of ways. For example, a format for the taxonomy structure may be specified. For example, a taxonomy structure may be desired in a table format, a hierarchical tree format, a bullet list format, etc. As another example, a desired number of layers or levels of the taxonomy structure may be specified. For instance, a single layer taxonomy may be desired. In other cases, a three-tier taxonomy structure may be desired. As another example, a desired number of categories or classifications may be indicated. For example, a desired number of total categories may be specified, a desired number of categories per tier or layer may be specified, and/or the like. By way of example only, a desired taxonomy structure may be specified to be in a table format, with each row representing an intent category, and a maximum of ten categories. Further, the schema of the taxonomy may be specified to include a title of the intent category, a description of the intent category, and/or a list of examples in the intent category. Such data may also be further defined. For example, a target number, maximum number, or minimum number of examples may be specified (e.g., target number of 3 examples for each category).

Taxonomy attributes generally refers to attributes or criteria for generating an intent taxonomy. Various attributes that may be specified include accuracy, completeness, conciseness, clarity, and/or consistency. Accuracy can refer to accuracy of definitions, descriptions of classes, properties, and individuals in a taxonomy. For example, at the time of validation, accuracy can refer to comparing annotations by at least two human assessors and computing inter-coder reliability (ICR). Comprehensiveness can refer to any data that should be reliably classified using the taxonomy. For example, at the time of taxonomy generation, comprehensiveness can be used to verify that the taxonomy considers as broad a scope as possible in the prompt. At the time of taxonomy validation, comprehensiveness can be used to consider what proportion of instances by human assessors end up in an “other” category. Conciseness can refer to the taxonomy not including any irrelevant elements with regard to the user intents (e.g., in AI chat). For example, at the time of application of an intent taxonomy, conciseness can refer to analyzing how well the generated and validated taxonomy serve the purpose of understanding user intents in logs (e.g., chat logs) after an LLM or human annotators use the taxonomy for annotation of test data. Clarity can refer to the taxonomy communicating the intended meaning of the defined terms in that definitions should be objective and independent of the context. For example, at the time of generation, clarity can refer to ensuring an LLM provides a detailed description of definition along with examples with each category. At the time of validation, clarity can refer to eliciting from the human assessors how clear the definitions and examples are for them. Consistency can refer to the taxonomy not including or allowing for any contradictions. For example, at the time of generation, consistency can refer to verifying that a MML generates an intent taxonomy where different categories do not overlap in their meanings. At the time of validation, consistency can refer to assessing how often the human assessors have difficulty distinguishing between two labels.

As described, weights associated with corresponding data can be provided in the model prompt to indicate an emphasis or focus to place on corresponding data in generating an intent taxonomy. For example, more recent training data may be more desired for consideration when generating an intent taxonomy and, as such, have a higher weight. As another example, certain taxonomy attributes may be more desired for consideration in generating an intent taxonomy (e.g., consistency may be more valued than conciseness and, as such, have a greater weight). As such, in accordance with including taxonomy generation data in a model prompt, in some cases, corresponding model weights can also be included.

Any other instructions indicating a desired output are contemplated within embodiments of the present technology. For instance, as another example, an output attribute may indicate a target language for generating the output. For example, the training data may be provided in one language (or a variety of languages), and an output attribute may indicate to generate the output in another language (or a single language).

The prompt generator 222 may format the data, such as training data, taxonomy structure, and taxonomy attributes in various forms or data structures. One example of a data structure for a model prompt is as follows:
{Primary Goal—Generate an intent taxonomy from given log data
{Log Data: Set of conversations and corresponding summary about what user task is performed in the conversation
{Desired Taxonomy Structure: Title of each intent category; Description of each intent category; Examples for each intent category
{Criteria of Taxonomy:
   {Accuracy—Definitions, descriptions, properties, and individuals in a taxonomy should be correct
   {Completeness—all data should be reliable classified using this taxonomy
   {Conciseness—Taxonomy should not include any irrelevant elements with regards to the user intents in AI chats
   {Clarity—Taxonomy should communicate the intended meaning of the defined terms; definitions should be objective and independent of the context
   {Consistency—Taxonomy does not include or allow for any contradictions
{Output Requirements:
   {Taxonomy should focus on the user actions in a task, not the task objects
   {Taxonomy should matching data as closely as possible without leaving out important intent categories or including unnecessary ones
   {Title of each category should be no more than five words
   {Description should be no more than 30 words
   {Number of examples should be no more than 3 for each category
   {Total number of categories should be no more than 10
   {Taxonomy, including examples, should be in English only

In some cases, the prompt generator 222 may include an existing taxonomy in the prompt for use in generating a new taxonomy. For example, an existing taxonomy may be used to organizing and/or understanding the provided training data. The existing taxonomy may be generated, for instance, via an analyst or algorithm, via a prior iteration of generating an intent taxonomy as described herein, and/or the like.

As described, in embodiments, the prompt generator 222 generates or configures model prompts in accordance with size constraints associated with a machine learning model. As such, the prompt generator 222 may be configured to detect the input size constraint of a model, such as an LLM or other machine learning model. Various models are constrained on a data input size they can ingest or process due to computational expenses associated with processing those inputs. For example, a maximum input size of 14096 tokens (for davinci models) can be programmatically set. Other input sizes may not necessarily be based on token sequence length, but other data size parameters, such as bytes. Tokens are pieces of words, individual sets of letters within words, spaces between words, and/or other natural language symbols or characters (e.g., %, $, !). Before a language model processes a natural language input, the input is broken down into tokens. These tokens are not typically parsed exactly where words start or end-tokens can include trailing spaces and even sub-words. Depending on the model used, in some embodiments, models can process up to 4097 tokens shared between prompt and completion. Some models (e.g., GPT-3) take the input, convert the input into a list of tokens, process the tokens, and convert the predicted tokens back to the words in the input. In some embodiments, the prompt generator 222 detects an input size constraint by simply implementing a function that calls a routine that reads the input constraints.

The prompt generator 222 can determine which data, for example, obtained by the data obtainer 220 is to be included in the model prompt. In some embodiments, the prompt generator 222 takes as input the input size constraint and the obtained data to determine what and how much data to include in the model prompt. By way of example only, assume a model prompt is being generated in relation to intent taxonomy generation. Based on the input size constraint, the prompt generator 222 can select which data, such as data requests and corresponding responses, to include in the model prompt. As described, such a data selection may be based on any of a variety of aspects, such as date of data, weights of data, and/or the like. As one example, the prompt generator 222 can first call for the input size constraint of tokens. Responsively, the prompt generator 222 can then tokenize each of the data, such as training data, to generate tokens and, thereafter, responsively and progressively add each data set ranked/weighted from highest to lowest if and until the token threshold (indicating the input size constraint) is met or exceeded, at which point the prompt generator 222 stops.

The prompt generator 222 may generate any number of model prompts. As one example, an individual model prompt may be generated for an entire set of training data. In this way, a one-to-one model prompt may be generated for a corresponding set of training data. As another example, a particular model prompt may be generated for different portions of training data. For instance, a first model prompt may be generated using a first portion of training data, a second model prompt may be generated using a second portion of training data, and a third model prompt may be generated using both the first and second portions of training data. In such cases, the additional instructions (e.g., related to taxonomy structure and/or desired taxonomy attributes) may be the same (or varied) for each model prompt. In cases in which multiple initial intent taxonomies are generated from different data, the intent taxonomies may be aggregated in a way that effectively represents the different intent taxonomies in an accurate manner. For instance, an analyst may evaluate the different intent taxonomies and select one intent taxonomy or modify an intent taxonomy to reflect aspects of another generated intent taxonomy.

The taxonomy generator 224 is generally configured to generate intent taxonomies. In this regard, the taxonomy generator 224 utilizes various training data, such as data requests and corresponding data responses, to generate an intent taxonomy. In embodiments, the taxonomy generator 224 can take, as input, a model prompt or set of model prompts generated by the prompt generator 222. Based on the model prompt, the taxonomy generator 224 can generate an intent taxonomy associated with the training data (e.g., data requests and corresponding responses) indicated in the model prompt. For example, assume a model prompt includes a set of AI chat requests and corresponding responses. In such a case, the taxonomy generator 224 generates an intent taxonomy for categorizing user intent based on the set of training data included in the model prompt.

Advantageously, as the intent taxonomy is generated based on prior data logs (e.g., search logs and/or chat logs), the intent taxonomy is generally generated using language that provides an indication or representation of most likely used intent classifications or categories. As such, the intent taxonomy can have applicability to future user data requests. Further, the intent taxonomy is generated in accordance with desired output attributes, thereby efficiently generating an effective intent taxonomy.

The taxonomy generator 224 may be or include any number of machine learning models or technologies. In some embodiments, the machine learning model is an LLM. A language model is a statistical and probabilistic tool which determines the probability of a given sequence of words occurring in a sentence (e.g., via next sentence prediction (NSP) or masked language model (MLM)). Simply put, it is a tool which is trained to predict the next word in a sentence. A language model is called a large language model when it is trained on enormous amount of data. In particular, a LLM refers to a language model including a neural network with an extensive amount of parameters that is trained on an extensive quantity of unlabeled text using self-supervising learning. Oftentimes, LLMs have a parameter count in the billions, or higher. Some examples of LLMs are GOOGLE's BERT and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes—all with limited to no supervision. Accordingly, an LLM is a deep neural network that is very large (billions to hundreds of billions of parameters) and understands, processes, and produces human natural language by being trained on massive amounts of text. In embodiments, an LLM performs automatic taxonomy generation. Although some examples provided herein include a single-mode generative model, other models, such as multi-modal generative models, are contemplated within the scope of embodiments described herein. Generally, multi-modal models are generated to make predictions based on different types of modalities (e.g., text and images).

As such, as described herein, the taxonomy generator 224, in the form of an LLM, can obtain the model prompt and, using such information in the model prompt, generate an intent taxonomy that can be used to classify user intent associated with data requests (e.g., search queries and/or chat inquiries). In some embodiments, the taxonomy generator 224 takes on the form of an LLM, but various other machine learning models can additionally or alternatively be used.

The taxonomy analyzer 226 is generally configured to analyze a generated taxonomy and, in some cases, facilitate updating or fine-tuning of the taxonomy. In this regard, the taxonomy analyzer 226 can be used to validate and/or test an intent taxonomy (e.g., generated via taxonomy generator 224) and, if needed, manage updating of the taxonomy. As described herein, in some embodiments, human assessors may be used to facilitate taxonomy analysis (e.g., validating and/or testing of the taxonomy). Advantageously, taxonomy analyzer 226 enables validation and/or fine-tuning of an intent taxonomy generated via a LLM, which is particularly useful when construction of the LLM and how it creates or links various concepts is unknown to a user.

As described, the taxonomy analyzer 226 can facilitate or manage validation and/or testing of a generated intent taxonomy. Intent taxonomy validation and/or testing can be performed in a number of ways. In embodiments, intent taxonomy validation and/or testing can be performed to validate various taxonomy attributes desired in association with the intent taxonomy. As described, taxonomy attributes may include, for example, comprehensiveness, consistency, clarity, accuracy, and/or conciseness. As such, taxonomy analyzer 226 can be used to determine whether desired criteria of comprehensiveness, consistency, clarity, accuracy, and/or conciseness is attained in a generated intent taxonomy.

As described, in some embodiments, human assessors are used to facilitate validation and/or testing of an intent taxonomy. In this regard, in some cases, a generated intent taxonomy is provided to human assessors (e.g., any number of individuals) along with portions of data (e.g., a set of training data requests and corresponding responses). The human assessors can independently classify or label the data (e.g., training data requests) into classes identified in the intent taxonomy. The assessor specified classifications or labels can be used to revise or update a current version of the intent taxonomy. For example, based on the assessor specified labels, a better understanding of what various labels mean could be formed and used to adjust the description of the user intent class(es) and/or corresponding examples.

In one implementation, the taxonomy analyzer 226 is used to validate an intent taxonomy based on comprehensiveness, consistency, and/or clarity. As one example, to verify comprehensiveness, a model prompt including a generated intent taxonomy along with sample(s) (e.g., training data requests and/or responses) can be generated and fed to an LLM (e.g., taxonomy generator 224 and/or intent identifier 234) to obtain output from the LLM in the form of classification labels for each sample. Each sample can be included in a separate model prompt, or a single model prompt may include each of the samples. In this model prompt, a request can be included to label any sample that does not fit a provided user intent class or label as “other.” Based on the output, comprehensiveness associated with the intent taxonomy can be identified. For example, assume a threshold value is determined for confirming comprehensiveness. As one example, a 5% threshold value may be used. In such an example, in cases in which more than 5% of samples are assigned to the “other” category, the intent taxonomy can be determined to not be as comprehensive as desired. In such cases, the intent taxonomy can be adjusted or fine-tuned to refine the taxonomy such that it is more comprehensive. For example, additional classes or levels may need to be added to the taxonomy for comprehensiveness. Determining such adjustments or fine-tuning of the intent taxonomy may be performed by a human (e.g., an assessor or analyst) or in an automated manner (e.g., via use of the taxonomy generator, for example, by generating a new model prompt using different or additional training samples, modifying instructions, such as instructions related to taxonomy structure and/or taxonomy attributes, or the like).

To analyze consistency, the taxonomy analyzer 226 can facilitate analysis of classes or labels generated for samples (e.g., training data requests and/or responses). In some cases, labels for each sample may be generated by generating a model prompt(s) that includes the generated intent taxonomy and samples and that requests classification labels for the samples as output. In other cases, a portion or sampling may be used to check for consistency of application of the intent taxonomy. For example, the taxonomy analyzer 226 may randomly select samples from the training data and include such samples in a model prompt, along with the generated intent taxonomy, and request output from an LLM (e.g., taxonomy generator 224 or intent identifier 234) in the form of a label or classification for each sample. Based on the output, the taxonomy analyzer 226 can analyze whether definitions of the various classes are consistently assigned. In some cases, multiple iterations may be performed to see if a sample(s) is assigned a same label in each iteration. The number of samples used and/or iterations of generating labels may vary and implemented based on preferences, size of data, type of data, desired level of consistency, etc.

To analyze clarity, the taxonomy analyzer 226 can facilitate expansion of classes or labels with more descriptions and/or examples to improve its clarity. As one example, the taxonomy analyzer may generate a model prompt to request description expansion and/or example expansion to fine-tune the clarity of the intent taxonomy. As can be appreciated, appropriate examples may be identified to feed to the LLM to facilitate clarity improvement. In some cases, the taxonomy analyzer 226 may analyze for clarity upon validating comprehensiveness and/or consistency of the intent taxonomy. For example, upon validating comprehensiveness and/or consistency of the intent, and/or fine-tuning to improve such attributes, the classifications in the taxonomy can be determined to be in final form. As such, the taxonomy analyzer 226 may then perform revision and/or expansion of definitions and/or descriptions for each label or class to improve clarity, as needed.

In embodiments, the taxonomy analyzer 226 is used to validate or test an intent taxonomy based on accuracy and conciseness. In some cases, to analyze accuracy, the taxonomy analyzer 226 can facilitate generation of labels of samples via a LLM (e.g., taxonomy generator 224). In this way, a model prompt can be generated that includes samples and the constructed intent taxonomy. In some cases, the samples may be or include training data, such as training data used to generate the intent taxonomy. Alternatively or additionally, the samples may be or include test data that was not used to generate the intent taxonomy. The model prompt can be input into an LLM to obtain, as output, labels or classifications of such data. In some implementations, the output labels can be compared to labels manually generated (e.g., via human assessors) to identify if the assigned label follows the definition for that label. In this way, the samples can be provided to human assessors to classify the samples (e.g., using the intent taxonomy). To the extent samples are identified as properly classified (e.g., above a threshold value) and/or minimal samples are assigned to an “other” category, the intent taxonomy can be determined to be accurate. Additionally or alternatively, inter-coder reliability (ICR) can be used to measure for accuracy. For instance, the automated labeled data, or a random sampling thereof, can be compared to human assessor labeled data (e.g., based on the same set of instructions as given to an LLM in a prompt). For the same data, the ICR between human annotations and those from the LLM are measured. Such an ICR measurement provides an indication of how accurate or valid an intent taxonomy is as well as the LLM's annotation capabilities. When the ICR is high, or exceeds a threshold, the intent taxonomy and the LLM can be considered to be thoroughly texted for implementation.

To analyze conciseness, the taxonomy analyzer 226 may analyze an intent taxonomy identified as a final taxonomy, that is, upon fine tuning or adjustments made based on taxonomy attributes. For instance, samples (e.g., training search queries and/or chat inquiries) may be provided as input, along with the fine-tuned intent taxonomy, to an LLM to obtain a set of corresponding labels. In cases that a minimal amount (e.g., below a threshold) of samples labeled as “other” are output, the taxonomy analyzer 226 can identify the fine-tuned taxonomy as concise. As another example, samples in the form of test data can be provided to a LLM, along with a fine-tuned taxonomy, for use in generating labels for the test data. In this regard, the test data can be independent from the training data, such that the test data was not used for training the intent taxonomy. In performing tests, the taxonomy analyzer 226 may determine whether a classification exists that is not assigned to enough test samples (e.g., does not exceed a threshold amount). If there is a generally unused classification, the class may be removed to improve conciseness associated with the taxonomy. As can be appreciated, in some cases, upon removing a category, updating the intent taxonomy may be needed as samples associated with the removed category may now fall under other categories, which may affect some of the criteria evaluated before.

In one embodiment, to analyze validity (e.g., comprehensiveness, consistency, clarity, accuracy, and/or conciseness), a large language model, such as the large language model discussed herein, or other model or machine may be utilized. In this regard, in some cases, the taxonomy analyzer 226 may prompt an LLM to analyze for validity such that machine validation is performed. As one example, an LLM may be prompted to analyze a human-generated label(s) against a machine-generated label(s) to analyze validity. As another example, an LLM may be prompted to analyze labels (e.g., human-generated labels and/or machine-generated labels) against threshold values, an “other” class, consistent assignments of classifications, etc. The prompt may be generated automatically or based on input indicating a desired performance of validity analysis.

The taxonomy provider 228 is generally configured to provide intent taxonomies. In this regard, upon generating an intent taxonomy(s), the taxonomy provider 228 can provide such data, for example for display via a user device. To this end, in cases in which the intent taxonomy manager 212 is remote from the analyst device, the taxonomy provider 228 may provide an intent taxonomy(s) to an analyst device for display to an analyst that initiated the request for viewing an intent taxonomy(s). In embodiments, the intent taxonomy is generated and provided for display in real time. In this way, in response to an indication to generate an intent taxonomy (e.g., directly or indirectly initiating generation of intent taxonomy by interacting with an application or website), an intent taxonomy is generated and provided to the analyst in real time. In some cases, to the extent the analyst views the intent taxonomy at a later time, the intent taxonomy can be updated in real time by performing generation or updating of the intent taxonomy (e.g., based on more recent data logs, such as search logs and/or chat logs) and providing the updated intent taxonomy in real time for viewing. In this way, at a first time of viewing an intent taxonomy, an analyst may view one version of an intent taxonomy, and at a second subsequent time, the analyst may view another, more updated, intent taxonomy.

Alternatively or additionally, an intent taxonomy may be provided to a data store for storage or another component or service. Such a component or service may then provide the intent taxonomy for display, for example, via an analyst device, or other device. For instance, as described herein, in some cases, an intent taxonomy may be generated in a periodic manner (e.g., upon validation in accordance with one or more human assessors). As one example, an intent taxonomy may be generated in off-hours (hours in which computing resources are more available and not used by other processes). Such an initially generated intent taxonomy can then be stored, for example in data store 214. Thereafter, one or more human assessors may assess the intent taxonomy to facilitate validation and/or testing of the intent taxonomy. In association with fine-tuning the initial intent taxonomy, the final intent taxonomy can be stored and/or provided for display.

The intent taxonomy may be provided for display in any number of ways. In some examples, the intent taxonomy is provided in accordance with the desired taxonomy structure (e.g., specified in the model prompt for generating the intent taxonomy). For example, an intent taxonomy may be presented in a table format, a hierarchical data structure format, a listing, and/or the like. In addition to the classifications or categories, the intent taxonomy may include other information such as a description of each classification, examples associated with each classification, and/or the like. In some cases, the intent taxonomy is automatically displayed. In other cases, a user may select to view the intent taxonomy. For instance, a link may be presented that, if selected, presents an intent summary.

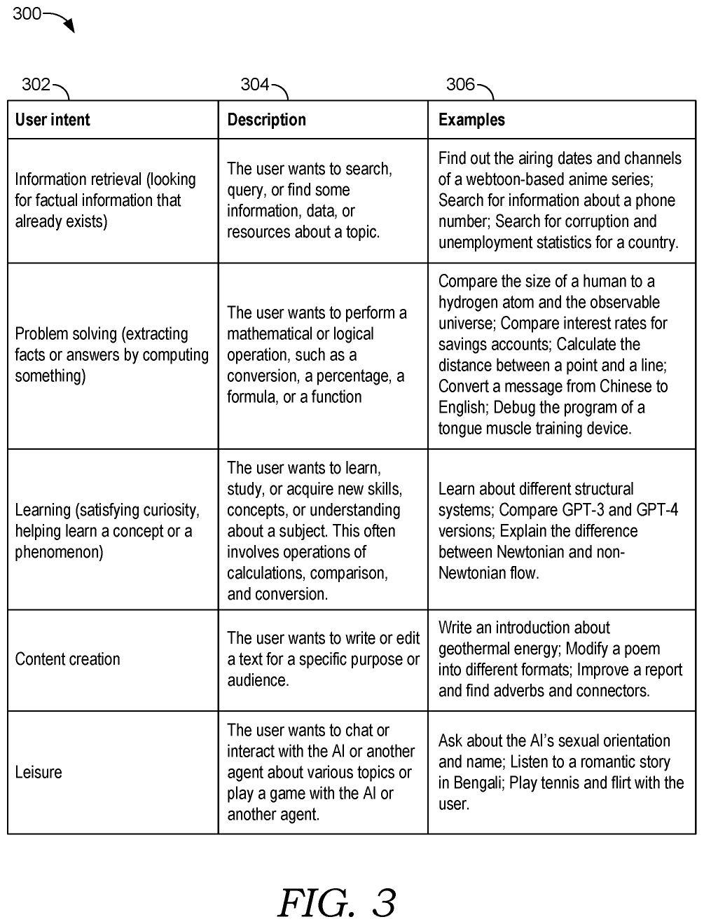

One example of an intent taxonomy structure 300 is provided in FIG. 3. In FIG. 3, the various user intent classes are presented as column 302. The user intent classes provide a name or title for each user intent class. The user intent taxonomy structure 300 also includes a description column 304 and an example column 306. The description column 304 includes a description or definition that provides guidance on the corresponding user intent. For example, with respect to the information retrieval user intent, the description specifies or describes this user intent class as a user wanting to search, query, or find some information, data, or resources about a topic. The examples column 306 includes various examples of samples that correspond with the user intent class. The examples may be in any form and any number may be provided. In some cases, the examples are in the same form as the training data (e.g., the exact data request). In other cases, the examples may be genericized to be more versatile or broad in providing an example.

Returning to FIG. 2, in addition or in the alternative to providing an intent taxonomy for display, an intent taxonomy can be provided for utilization, for example, to identify a user intent class for an input (e.g., a search query and/or chat inquiry), as described more fully below. In this regard, the taxonomy provider 228 can provide an intent taxonomy to intent identification manager 218 or store for access by the intent identification manager 218.

Turning to the intent identification manager 218, the intent identification manager 218 is generally configured to identify user intent associated with inputs, such as data requests (e.g., search queries and/or chat inquiries) or conversations. In embodiments, the intent identification manager 218 includes an intent identification data obtainer 230, a prompt generator 232, an intent identifier 234, and an intent provider 236. According to embodiments described herein, the intent identification manager 218 can include any number of other components not illustrated. In some embodiments, one or more of the illustrated components 230, 232, 234, and 236 can be integrated into a single component or can be divided into a number of different components. Components 230, 232, 234, and 236 can be implemented on any number of machines and can be integrated, as desired, with any number of other functionalities or services.

The intent identification manager 218 may receive input 250 to initiate generation and/or providing of an intent identification in association with a data request (or conversation). Input 250 may include an intent identification request 254. An intent identification request 254 generally includes a request or indication to identify a user intent, for example, in association with a data request. An intent identification request may specify, for example, a data request(s), such as a search query(s) or a chat inquiry(s), a conversation, etc.

An intent identification request 254 may be provided by any service or device. For example, in some cases, an intent identification request 254 may be initiated and communicated via a user device, such as user device 110 of FIG. 1. For example, assume an analyst desires to use a taxonomy to analyze user intent (e.g., via a website or application) associated with data requests (e.g., search queries or chat inquiries). In such a case, an intent identification request 254 may be initiated that includes a request to identify user intent associated with a data request(s). As another example, an intent identification request 254 may be initiated and communicated via a user device, such as a user device from which a data request is generated or submitted, or a search or chat service that obtains the data request. For instance, assume a user inputs a search query or chat inquiry. To facilitate the search and/or chat response, user intent associated with the data request may be desired and, as such, an intent identification request may be generated. In one example, the intent identification request 254 may specify a set of one or more data requests and/or data responses. Further, in some cases, the intent identification request 254 indicates or includes an intent taxonomy to use for identifying or classifying an intent associated with a data request. An intent identification request can be generated in any of a number of ways, including via an input or command, via selection of a link or button, and/or the like.

Alternatively or additionally, an intent identification request 254 may be automatically initiated and communicated to intent identification manager 218. For example, a website or application service, such as search service or search analysis service, that uses an intent taxonomy(s) may automatically initiate intent identification requests, for instance, based on input of a data request by a user, obtaining a set of data requests, or other criteria. As can be appreciated, the automated initiation of an intent identification may be dynamically determined, for instance, based on attributes associated with a data request(s). For example, in cases in which a data request is obtained in association with a particular user or user device, an intent identification request may be initiated.

Although not illustrated, input 250 may include other information communicated in association with an intent identification request 254. For example, the intent taxonomy, or indication thereof, may be provided in association with the intent identification request.

The intent identification data obtainer 230 is generally configured to obtain intent identification data. In this regard, in some cases, the intent identification data obtainer 230 obtains data in accordance with obtaining an intent identification request, such as intent identification request 254. Intent identification data generally refers to any data associated with identifying intent in connection with a data request(s). In this regard, intent identification data may include, but is not limited to, data requests, data responses, user interactions, a conversation, data contexts, and/or the like. A data request generally refers to a request for data. As previously described, in some cases, a data request is in the form of a search query (e.g., in association with a search engine). In other cases, a data request is in the form of a chat inquiry (e.g., in association with an AI-driven chat service). A data response generally refers to a response associated with a data request. In this way, a data response can be a response provided or identified for providing (e.g., to a user) in response to a data request. For example, a data response may be a search result or set of search results provided or to provide in response to a search query. As another example, a data response may be an answer provided or to provide in response to a chat inquiry. A user interaction generally refers to any interaction in association with a data response. For example, a user interaction may include selection or modification of a search result or data request. A conversation refers to a set of data associated with a topic. For instance, a conversation may include a data request and a response thereto. As another example, a conversation may include a data request, a response thereto, a user interaction associated with the data request and/or response, etc. A data context generally refers to any context associated with a data request, data response, user interaction, and/or conversation. For example, data context may include a time, a frequency, a user device, and/or a user associated with a data request, data response, and/or user interaction. As can be appreciated, such intent identification data can be in any of a number of formats, such as text, images, videos, audio, and/or the like.

The intent identification data obtainer 230 can receive or obtain data from various sources for utilization in identifying a user intent class(s). As described above, in some cases, intent identification data may be obtained as input 250 along with the intent identification request 252. For example, in some implementations, a user may input or select a search query or chat inquiry, via a graphical user interface, for obtaining results or an answer.

Additionally or alternatively, the intent identification data obtainer 230 may obtain intent identification data from any number of sources or data stores, such as data store 214. In this regard, in accordance with initiating user intent identification associated with a group of data requests, the intent identification data obtainer 230 may communicate with a data store(s) or other data source(s) and obtain data (e.g., in the form of logs). Such intent identification data that may be obtained includes, for example, data requests, data responses, user interactions, data contexts, and/or the like. Data store 214 illustrated in FIG. 2 may include such data, but any number of data stores and/or data sources may provide various types of data. Such data stores and data sources may include public data, private data, and/or the like. For instance, a search service (e.g., website or application) may store log data associated with various searches, including search queries, search results, and/or user selections associated therewith. As another example, a chat service (e.g., website or application) may store log data associated with various AI-based chat requests, including chat inquiries, responses, and/or user interactions associated therewith.

In some cases, the intent identification data obtainer 230 may identify a type or extent of data to obtain. For example, assume an intent identification request 254 corresponds with an indication of a data log (e.g., associated with a particular search or chat service). For instance, a website service associated with a data log may provide an intent identification request indicating the data log to use for analyzing data requests. Upon identifying the data log, the intent identification data obtainer 230 may obtain data requests and corresponding data responses from the data log. As another example, assume an intent identification request 252 is provided in association with a particular data request (e.g., search query or chat inquiry). In such a case, the intent identification data obtainer 230 may obtain a particular intent taxonomy. For example, for an intent identification request associated with a search query, an intent taxonomy generated based on search logs may be obtained. On the other hand, for an intent identification request associated with a chat inquiry, an intent taxonomy generated based on chat logs may be obtained.

The intent identification data obtainer 230 may also obtain any amount of data. For example, in some cases, an entire set of log data may be obtained for identifying corresponding user intents in a batch manner. In other cases, only a portion of log data may be obtained. For example, a portion of log data (e.g., randomly assigned or based on an attribute such as a time) is used to identify corresponding user intent. In yet another example, a single data request, or corresponding conversation, for which user intent is desired may be obtained. The type and amount of data obtained by intent identification data obtainer 230 may vary per implementation and is not intended to limit the scope of embodiments described herein.

The prompt generator 232 is generally configured to generate model prompts, which may be performed in a similar manner as that described with respect to prompt generator 222. Although illustrated as separate prompt generators, a single prompt generator, or any other number of prompt generators may be used. As described herein, a model prompt generally refers to an input, such as a text input, that can be provided to intent identifier 234, such as an LLM, to generate an output in the form of an intent identification (e.g., user intent class or label). In embodiments, a model prompt to identify intent generally includes a data request(s) (or conversation(s)) and in indication of an intent taxonomy. In some cases, the model prompt may include a data request and corresponding data response and/or user interactions. The intent taxonomy may be referenced or indicated in the model prompt, or provided directly in the model prompt, for use in identifying user intent associated with the data request. The model prompt may include additional data. For example, in some cases, the model prompt may include historical log data associated with the user (e.g., such that prior data requests and/or responses can be analyzed).

In embodiments, the prompt generator 232 is configured to select a set of data requests for which to identify user intent(s). For example, assume user intent is to be identified for a set of AI chat requests and a chat log is obtained. In such a case, the prompt generator 232 may select a set of chat requests for which to identify user intent. In this way, after log data is obtained, the prompt generator 232 may select a portion of log data for which to identify user intent. Such data may be selected based on any number of type of criteria, some of which are described above in association with selection of training data.

In other cases, the prompt generator 232 utilizes the obtained data. For example, in some cases, the intent identification data obtainer 230 may obtain a data request (e.g., based on a user input query or chat inquiry), and the prompt generator 232 uses such an obtained data request to generate a model prompt.

In addition to the model prompt including a data request(s) for which user intent identification is desired and an intent taxonomy, a model prompt may also include output attributes. As described, output attributes generally indicate desired aspects associated with an output, such as a user intent class. By way of example, output attributes may include a number of user intent classes that may be identified for a data request, a likelihood (e.g., probability) of a user intent class, the like. For instance, assume a conversation or set of conversations is provided as input for which to identify a user intent class. In such a case, output attributes may indicate to output a single, primary user input label and a maximum of three secondary user input labels. As another example, an output attribute may indicate a target language for generating the output. For example, the data request may be provided in one language, and an output attribute may indicate to generate the output in another language. Any other instructions indicating a desired output are contemplated within embodiments of the present technology.

The prompt generator 232 may format the intent identification data in various forms or data structures. One example of a data structure for a model prompt is as follows:
{Data request(s) and corresponding responses/user interactions
{Intent Taxonomy including user intent classes, class descriptions, and class examples:
   Information Retrieval: Conversations where the user wants to find factual information or answers to specific questions. The agent's responses are typically direct, concise, and informative, providing the relevant information and/or links to the sources. This intent calls for retrieving or reconstructing factual information that already exists, rather than synthesizing or computing something new.
   Problem Solving: Conversations where the user wants to perform a mathematical or logical operation, such as a conversion, a percentage, a formula, or a function. The agent's responses are typically factual and computed or constructed based on available information and what the user provided. Unlike Information Retrieval intent, this intent calls for the agent to do some processing on top of simply retrieving or extracting information.
   Learning: Conversations where the user wants to understand a concept or acquire skills by getting detailed explanation, reasoning, or synthesis. The agent's responses are typically a synthesis of information based on several factual pieces of information, often from different sources. The Learning intent requests often involve questions like ‘how’, ‘why’, or requests like ‘explain’—things that will indicate asking for explanations or doing investigation. Also, while individual turns may be of information retrieval nature, if the user is asking multiple questions that drill into a topic, that's an indication of Learning intent.
   Content Creation: Conversations where the user asks the agent to either generate original content or translate existing content into new content based on specified criteria or constraints. In the case of generating original content, the user's questions require some degree of creativity, novelty, or innovation from the agent. The agent's responses contain original or translated outputs that match the user's specifications.
   Leisure: Conversations where the user wants to chat or play with the agent out of curiosity, boredom, or humor, or else explore broad ideas or areas of interest without a specific goal or information need in mind. There may not even be a specific question or a request. The agent's responses are typically suggestive and engaging. The agent may also encourage further inquiry or action from the user to deepen their discovery experience.
   Other: This intent label can be used if none of the above labels fit. Note that you should do your best to find an appropriate label from the list above and only in the rare circumstances when you have very little to no confidence in that ability, you can use ‘Other’ label.
{Output Attributes
   {Target Language

As described, in embodiments, the prompt generator 232 generates or configures model prompts in accordance with size constraints associated with a machine learning model, as described herein with respect to prompt generator 222. The prompt generator 232 may generate any number of model prompts. As one example, an individual model prompt may be generated for an entire set of data requests or conversations. As another example, a particular model prompt may be generated for a particular data request (or conversation). For instance, a first model prompt may be generated for a first data request, and a second model prompt may be generated for a second data request.

The intent identifier 234 is generally configured to identify user intent associated with data requests, or data associated therewith (e.g., conversations). In this regard, the intent identifier 234 utilizes an intent taxonomy to identify user intent associated with a data request. Stated differently, the intent identifier 234 classifies a data request into a user intent class or category of an intent taxonomy. In embodiments, the intent identifier 234 can take, as input, a model prompt or set of model prompts generated by the prompt generator 232. Based on the model prompt, the intent identifier 234 can identify user intent associated with one or more data requests indicated in the model prompt. For example, assume a model prompt includes a set of AI chat requests and corresponding responses. In such a case, the intent identifier 234 identifies a user intent class for each AI chat request based on the intent taxonomy included in the model prompt.

The intent identifier 234 may be or include any number of machine learning models or technologies. In some embodiments, the machine learning model is an LLM. As such, as described herein, the intent identifier 234, in the form of an LLM, can obtain the model prompt and, using such information in the model prompt, identify a user intent class for each data request and/or conversation. Although intent identifier 234 is illustrated as separate from taxonomy generator 224, in some cases, a same LLM is used to perform the functionalities described herein.

The intent provider 236 is generally configured to provide identified user intents. In this regard, upon identifying a user intent, or user intent class, for a data request, the intent provider 236 can provide such data, for example for display via a device (e.g., analyst device and/or user device). To this end, in cases in which the intent identification manager 218 is remote from the analyst device or user device, the intent provider 236 may provide a user intent(s) for display associated with initiating a request for user intent. In embodiments, user intent is generated and provided for display in real time. In this way, in response to an indication to identify user intent, a user intent is identified and provided for display in real time.

Alternatively or additionally, user intent labels may be provided to a data store for storage or to another component or service. Such a component or service may then provide the user intent for display, for example, via a user device. For instance, as described herein, in some cases, user intent may be identified in a periodic or batch manner. As one example, user intent may be generated in off-hours (hours in which computing resources are more available and not used by other processes). Such identified user intents and corresponding data requests/conversations can then be stored, for example in data store 214.

User intents may be provided for display in any number of ways. In some examples, the user intent is provided in accordance with the corresponding data request/conversation. In addition to the user intents and corresponding data request/conversation, other information may be presented, such as a probability or likelihood associated with the user intent. In some cases, the use intent and corresponding information is automatically displayed. In other cases, a user may select to view such information. For instance, a link may be presented that, if selected, presents user intents.

In addition or in the alternative to providing user intents for display, user intents can be provided for utilization, for example, to analyze data requests, to analyze user input classes, to provide recommendations, and/or the like. In this regard, the intent provider 236 provides user intents and, in some cases, corresponding data (e.g., data requests) for analysis (e.g., via a search or chat engine). As one example, user intents, and corresponding information, may be provided to an analyst device, such as analyst device 110 of FIG. 1. The analyst device may analyze the user intents, determine trends associated with the user intents, identify marketing or search result approaches in associated with user intents, etc. As another example, user intents, and corresponding information, may be provided to a search service or a chat service. The search service or chat service may then use such information to provide recommendations or results. By way of example only, assume a user intent is identified for a particular chat inquiry provided by a user. In such a case, the chat service may use the user intent to provide more relevant information or provide a recommendation related to the user intent (e.g., an alternative chat inquiry, a suggested output attribute to include in a subsequent chat inquiry, etc.).

### Exemplary Implementations for Efficiently Generating and Using Intent Taxonomies

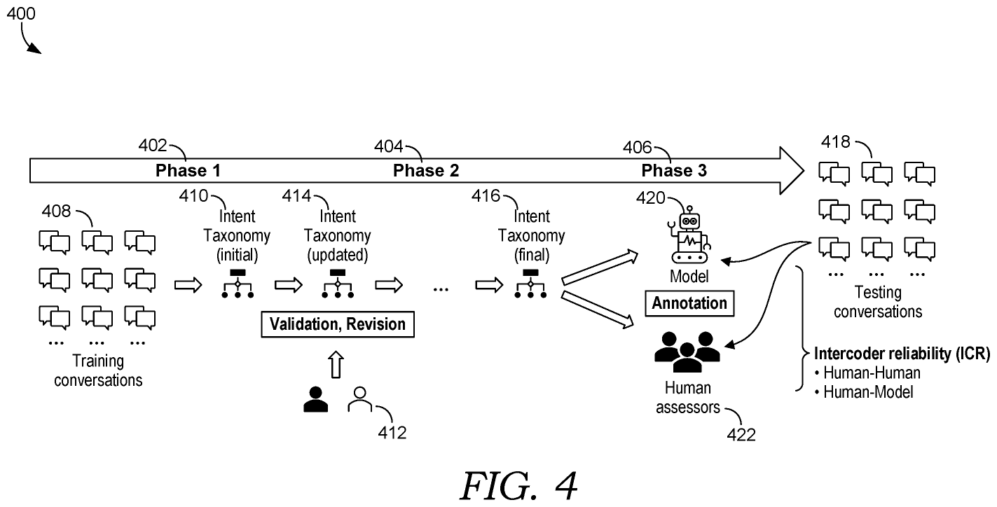

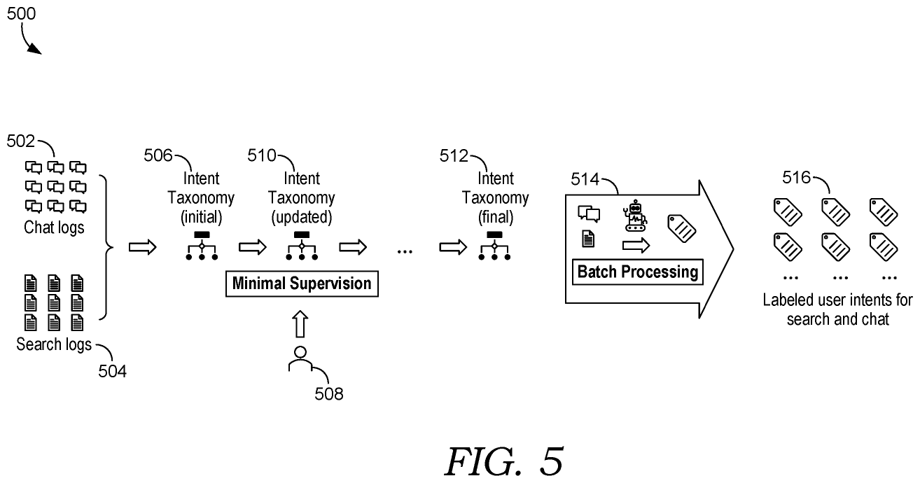

FIGS. 4-5 provide example implementations that illustrate various aspects of embodiments described herein. As shown, FIG. 4 provides one example implementation 400 that enables generating, validating, and testing an intent taxonomy. The first phase 402 includes generating an initial intent taxonomy. As shown, various training conversations 408 are included in a model prompt input into an LLM to result in an initial intent taxonomy 410. By way of example only, assume 1,000 conversations are obtained. In such a case, the conversations may be separated into different sets to generate corresponding intent taxonomies. For instance, a first model prompt may be used to generate an intent taxonomy associated with a first set of 500 conversations, a second model prompt may be used to generate an intent taxonomy associated with a second set of 500 conversations, and a third model prompt may be used to generate an intent taxonomy associated with all 1,000 conversations. Each of the generated intent taxonomies can be analyzed to understand common themes as well as differences. Based on the analysis, a consolidated initial version of the intent taxonomy can be generated. In some cases, the consolidated initial version may be a selection of one of the three intent taxonomies. In other cases, the consolidated initial version may include modifications made to one of the intent taxonomies. The initial intent taxonomy may include various aspects, such as, for example, a set of user intent classes, a description for each of the user intent classes, and a set of examples corresponding with user intent classes.

The second phase 404 includes validating the generated intent taxonomy 410. In one embodiment, the initial intent taxonomy 410 is provided to human assessors 412 along with one or more of the training conversations 408. For example, a portion or sampling of the training conversations 408 may be provided to the human assessors 412. The human assessors 412 can independently label the training conversations 408. The human-labeled conversations can be compared with one another. In an effort to attempt to reach a higher level of agreement, aspects learned in relation to various labels can be used to modify or revise the initial user intent taxonomy to result in an updated intent taxonomy 414. In some cases, the human-labeled conversations can be additionally or alternatively compared to machine-learned conversations (e.g., via a LLM) to learn enhancements for the intent taxonomy. By way of example only, by comparing various human-labeled conversations, it may be identified that several categories have similarities, such as information retrieval, problem solving, and learning. As such, the understanding of differences between the categories can be used to modify the description of user intent labels and/or examples of user intent labels. The updated intent taxonomy 414 can then be provided as the completed or final intent taxonomy 416.

The third phase 406 includes testing the final intent taxonomy 416. To test the final intent taxonomy 416, user intent labels are generated for a set of testing conversations 418. In this regard, a model 420, such as a LLM, is used to annotate or label the set of testing conversations 418. In particular, the model 420 can use the final intent taxonomy 416 to generate the user intent labels. The testing conversations 418, along with the final intent taxonomy, can be provided to human assessors 422 for determining user intent labels. The ICR can be measured between the human-provided user intent labels. A Cohen's kappa above a threshold value can indicate a substantial level of agreement between the human assessors. Further, the ICR between the human-provided user intent labels (e.g., labels generated by a majority of human assessors) and the machine-generated user intent labels can be measured. Again, a Cohen's kappa above a threshold value can indicate a substantial level of agreement between the human assessors and the machine-generated user intent labels. Generally, intent taxonomies generated by an LLM and verified by humans results in a very high amount of agreement, thereby indicating the validity of the intent taxonomy.

Turning to FIG. 5, FIG. 5 provides one example implementation 500 that enables generating and using an intent taxonomy. In this implementation, human intervention is utilized to perform light-touch validations. Such an implementation reduces the workload, speeds up taxonomy generation and application, and produces trustworthy instruments, labels, and insights. In this implementation illustrated in FIG. 5, chat logs 502 and search logs 504 are used to generate a user intent taxonomy. The chat logs 502 and the search logs 504 are provided as input (e.g., via a model prompt) to a model (e.g., a LLM) to generate an initial intent taxonomy 506. In embodiments, the model prompt can indicate goals, the data contained, criteria and/or constraints. For instance, a model prompt may specify a taxonomy of user intents is desired with no more than five categories and criteria for a good taxonomy include accuracy, completeness, conciseness, clarity, and consistency. With minimal supervision via human assessor(s) 508, an updated intent taxonomy 510 can be generated. In particular, human assessor(s) 508 can be used to validate the intent taxonomy and modify or update as needed based on analysis of the intent taxonomy. The final intent taxonomy 512 can be used to process new data requests for user intent labeling. In some cases, a LLM can be used to identify user intents associated with a batch of data requests. In this regard, the final intent taxonomy 512 and new data requests can be provided as input to a LLM, which can then output labeled user intents for search and chat 516.

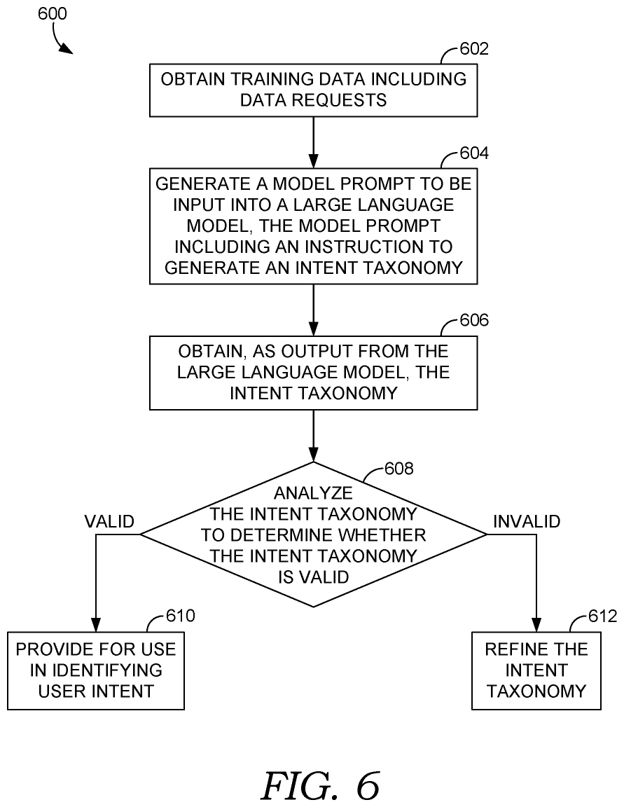

As described, various implementations can be used in accordance with embodiments described herein. FIGS. 6-8 provide methods of facilitating efficient generation and utilization of intent taxonomies. Methods 600, 700, and 800 can be performed by a computer device, such as device 900 described below. The flow diagrams represented in FIGS. 6-8 are intended to be exemplary in nature and not limiting.

Turning initially to method 600 of FIG. 6, method 600 is directed to facilitating efficient generation of intent taxonomies, in accordance with embodiments of the present technology. Initially, at block 602, training data is obtained. Training data may include data requests (e.g., search queries and/or chat inquiries), data responses, user interactions, and/or the like. In embodiments, training data may include log data, such as a search log or chat log. In some cases, the training data may be in the form of conversations, with each conversation including a data request and corresponding data (e.g., responses and user interactions associated with the data request).

At block 604, a model prompt to be input into a large language model is generated. In embodiments, the model prompt includes an instruction to generate an intent taxonomy, an indication of the training data to use for generating the intent taxonomy, and a taxonomy attribute desired to be used as criteria to generate a quality intent taxonomy. A taxonomy attribute may be an accuracy criteria, a completeness criteria, a conciseness criteria, a clarity criteria, or a consistency criteria for use in generating a quality intent taxonomy. In some cases, the model prompt also includes an indication of a desired taxonomy structure, such as related to structure specifies information to provide in the intent taxonomy, a number of user intent classes, a number of examples to provide in association with each user intent class, a number of hierarchical levels in the intent taxonomy, and/or the like.

At block 606, the intent taxonomy is obtained as output from the large language model. The intent taxonomy generally includes one or more user intent classes. The user intent classes can be organized in a multi-level hierarchical manner or in one level. Any number of user intent classes can be included in the intent taxonomy. In some embodiments, the intent taxonomy includes a description associated with each user intent class of the one or more user intent classes and an example associated with each user intent class of the one or more user intent classes.

At block 608, the intent taxonomy is analyzed to determine whether the intent taxonomy is valid. When the intent taxonomy is determined as valid, the intent taxonomy is provided for use in identifying user intent, as indicated at block 610. For example, for a new data request, user intent associated therewith may be determined. On the other hand, when the intent taxonomy is determined as invalid, the intent taxonomy is refined, as indicated at block 612. Refining the intent taxonomy may include, for example, updating the intent taxonomy with a new user intent class, a new example, or a new description or updating the intent taxonomy by removing a user intent class, an example, or a description. Analyzing the intent taxonomy to determine whether the intent taxonomy is valid can be performed in any of a number of ways. As one example, determining validity may include verifying comprehensiveness of the intent taxonomy by generating a prompt to annotate samples using the intent taxonomy; providing the prompt as input to the large language model; obtaining, as output, user intent class labels for the samples; and based on the user intent class labels, determining a proportion of the samples that have a user intent class label corresponding with a user intent class of the intent taxonomy. As another example, determining validity may include verifying consistency of the intent taxonomy by generating a prompt to annotate samples using the intent taxonomy; providing the prompt as input to the large language model; obtaining, as output, user intent class labels for the samples; and based on the user intent class labels, determining if the large language model consistently applied definitions associated with the one or more user intent classes. As yet another example, determining validity may include verifying conciseness of the intent taxonomy by generating a prompt to annotate test samples using the intent taxonomy; providing the prompt as input to the large language model; obtaining, as output, user intent class labels for the samples; and based on the user intent class labels, determining if a threshold number of samples have a user intent class label associated with each user intent class of the one or more user intent classes. Additionally or alternatively, validation can be determined by verifying accuracy of the intent taxonomy by generating a prompt to annotate test samples using the intent taxonomy; providing the prompt as input to the large language model; obtaining, as output, user intent class labels for the samples; comparing the user intent class labels output from the large language model to human-annotated user intent class labels for the test samples; and based on the comparison, determining of the intent taxonomy. In some cases, comparing the user intent class labels output from the large language model to the human-annotated user intent class labels includes measuring an inter-coder reliability therebetween.

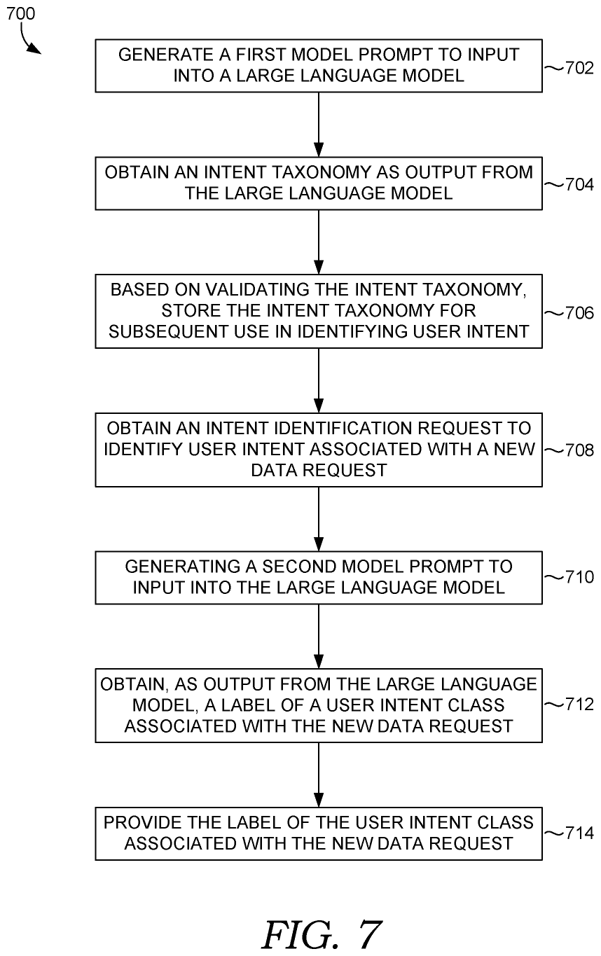

Turning now to FIG. 7, method 700 is directed to efficiently generating and using intent taxonomies, in accordance with embodiments of the present technology. Initially, at block 702, a first model prompt to input into a large language model is generated. The first model prompt can include an instruction to generate an intent taxonomy and an indication of training data, including data requests, to use for generating the intent taxonomy, among other things. At block 704, an intent taxonomy is obtained as output from the large language model. The intent taxonomy can include one or more user intent classes based on the training data. In some embodiments, the intent taxonomy includes descriptions of the one or more user intent classes and examples associated with the one or more user intent classes. At block 706, based on validating the intent taxonomy, the intent taxonomy is stored for subsequent use in identifying user intent. Validating the intent taxonomy can occur in any of a number of ways. For example, in some cases, validating the intent taxonomy includes using human-labeled user intent associated with data samples. For examples, a human assessor can assess data samples (such as training or test data requests) and determine user intent associated with such data samples. At block 708, an intent identification request to identify user intent associated with a new data request is obtained. At block 710, a second model prompt to input into the large language model is generated. The second model prompt can include the intent taxonomy and an instruction to identify user intent associated with the new data request. At block 712, a label of a user intent class associated with the new data request is obtained as output from the large language model. At block 714, the label of the user intent class associated with the new data request is provided for display via a user interface or for analysis of the user intent corresponding with the new data request. As one example, a new data request can be obtained from a user device. The new data request may be a search query or a chat inquiry. The label of the user intent class associated with the new data request can then be used to generate a recommendation associated with the new data request to provide to the user device.

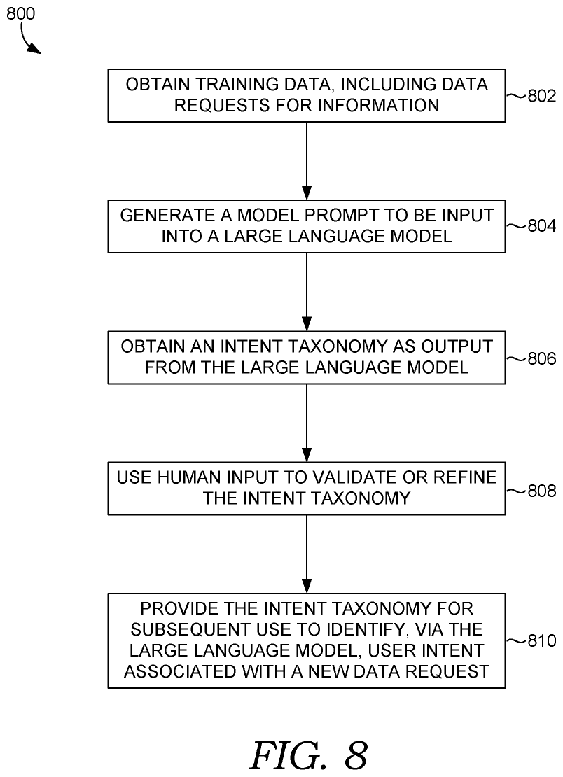

With reference now to FIG. 8, method 800 is directed to facilitating efficient generation and utilization of intent taxonomies, in accordance with embodiments of the present technology. Initially, at block 802, training data, including data requests for information, is obtained. At block 804, a model prompt to be input into a large language model is generated. The model prompt may include an instruction to generate an intent taxonomy, an indication of the training data to use for generating the intent taxonomy, and a taxonomy attribute desired to be used as criteria to generate a quality intent taxonomy. At block 806, an intent taxonomy is obtained as output from the large language model. The intent taxonomy can include one or more user intent classes. At block 808, human input is used to validate or refine the intent taxonomy. Human input may include, for example, recommendations for modifying the one or more user intent classes, descriptions associated with the one or more user intent classes, or examples associated with the one or more user intent classes. Additionally or alternatively, human input includes human-labeled user intent associated with data samples. In such cases, the human-labeled user intent can be compared with machine-labeled user intent generated via the large language model. At block 810, the intent taxonomy is provided for subsequent use to identify, via the large language model, user intent associated with a new data request.

Accordingly, we have described various aspects of technology directed to systems and methods for intelligently generating and using intent taxonomies. It is understood that various features, sub-combinations, and modifications of the embodiments described herein are of utility and may be employed in other embodiments without reference to other features or sub-combinations. Moreover, the order and sequences of steps shown in the example methods 600, 700, and 800 are not meant to limit the scope of the present disclosure in any way, and in fact, the steps may occur in a variety of different sequences within embodiments hereof. Such variations and combinations thereof are also contemplated to be within the scope of embodiments of this disclosure.

In some embodiments, a computerized system, such as the computerized system described in any of the embodiments above, comprises one or more processors, and one or more computer storage media storing computer-useable instructions that, when executed by the one or more processors, cause the one or more processors to perform operations. The operations comprise obtaining training data including data requests for information. The operations may further comprise generating a model prompt to be input into a large language model, the model prompt including an instruction to generate an intent taxonomy, an indication of the training data to use for generating the intent taxonomy, and a taxonomy attribute desired to be used as criteria to generate a quality intent taxonomy. The operations may further comprise obtaining, as output from the large language model, the intent taxonomy that includes one or more user intent classes. The operations may further comprise analyzing the intent taxonomy to determine whether the intent taxonomy is valid. When the intent taxonomy is determined as valid, the intent taxonomy is provided for use in identifying user intent, and when the intent taxonomy is determined as invalid, the intent taxonomy is refined. In this way, embodiments, as described herein, enable efficient generation of intent taxonomies via use of trained machine learning models, such as a large language model, without requiring fine-tuning of the model. Further, in this way, embodiments, as described herein, a quality intent taxonomy is generated for use in accurately identifying user intent.

In any combination of the above embodiments of the computerized system, the data requests include search queries or chat inquiries.

In any combination of the above embodiments of the computerized system, the training data further includes data responses, user interactions, or a combination thereof.

In any combination of the above embodiments of the computerized system, the taxonomy attribute comprises an accuracy criteria, a completeness criteria, a conciseness criteria, a clarity criteria, or a consistency criteria.

In any combination of the above embodiments of the computerized system, the model prompt further includes an indication of a desired taxonomy structure.

In any combination of the above embodiments of the computerized system, the desired taxonomy structure specifies information to provide in the intent taxonomy, a number of user intent classes, a number of examples to provide in association with each user intent class, a number of hierarchical levels in the intent taxonomy, or a combination thereof.

In any combination of the above embodiments of the computerized system, the intent taxonomy includes a description associated with each user intent class of the one or more user intent classes and an example associated with each user intent class of the one or more user intent classes.

In any combination of the above embodiments of the computerized system, refining the intent taxonomy includes updating the intent taxonomy with a new user intent class, a new example, or a new description or updating the intent taxonomy by removing a user intent class.

In any combination of the above embodiments of the computerized system, analyzing the intent taxonomy to determine whether the intent taxonomy is valid comprises verifying comprehensiveness of the intent taxonomy by generating a prompt to annotate samples using the intent taxonomy; providing the prompt as input to the large language model; obtaining, as output, user intent class labels for the samples; and based on the user intent class labels, determining a proportion of the samples that have a user intent class label corresponding with a user intent class of the intent taxonomy.

In any combination of the above embodiments of the computerized system, analyzing the intent taxonomy to determine whether the intent taxonomy is valid comprises verifying consistency of the intent taxonomy by generating a prompt to annotate samples using the intent taxonomy; providing the prompt as input to the large language model; obtaining, as output, user intent class labels for the samples; and based on the user intent class labels, determining if the large language model consistently applied definitions associated with the one or more user intent classes.

In any combination of the above embodiments of the computerized system, analyzing the intent taxonomy to determine whether the intent taxonomy is valid comprises verifying conciseness of the intent taxonomy by generating a prompt to annotate test samples using the intent taxonomy; providing the prompt as input to the large language model; obtaining, as output, user intent class labels for the samples; and based on the user intent class labels, determining if a threshold number of samples have a user intent class label associated with each user intent class of the one or more user intent classes.

In any combination of the above embodiments of the computerized system, analyzing the intent taxonomy to determine whether the intent taxonomy is valid comprises verifying accuracy of the intent taxonomy by generating a prompt to annotate test samples using the intent taxonomy; providing the prompt as input to the large language model; obtaining, as output, user intent class labels for the samples; comparing the user intent class labels output from the large language model to human-annotated user intent class labels for the test samples; and based on the comparison, determining of the intent taxonomy.

In any combination of the above embodiments of the computerized system, comparing the user intent class labels output from the large language model to the human-annotated user intent class labels comprises measuring an inter-coder reliability therebetween.

In other embodiments, a computer-implemented method is provided. The method includes generating a first model prompt to input into a large language model, the first model prompt including an instruction to generate an intent taxonomy and an indication of training data, including data requests, to use for generating the intent taxonomy. The method may further include obtaining, as output from the large language model, the intent taxonomy that includes one or more user intent classes based on the training data. The method may further include based on validating the intent taxonomy, storing the intent taxonomy for subsequent use in identifying user intent. The method may further include obtaining an intent identification request to identify user intent associated with a new data request. The method may further include generating a second model prompt to input into the large language model, the second model prompt including the intent taxonomy and an instruction to identify user intent associated with the new data request. The method may further include obtaining, as output from the large language model, a label of a user intent class associated with the new data request. The method may further include providing the label of the user intent class associated with the new data request for display via a user interface or for analysis of the user intent corresponding with the new data request. In this way, embodiments, as described herein, enable efficient generation and use of intent taxonomies via use of trained machine learning models, such as a large language model, without requiring fine-tuning of the model. Further, in this way, embodiments, as described herein, a quality intent taxonomy is generated for use in accurately identifying user intent.

In any combination of the above embodiments of the computer-implemented method, validating the intent taxonomy includes using human-labeled user intent associated with data samples.

In any combination of the above embodiments of the computer-implemented method, the method may further include obtaining the new data request from a user device, the new data request comprising a search query or a chat inquiry; and using the label of the user intent class associated with the new data request to generate a recommendation associated with the new data request to provide to the user device.

In any combination of the above embodiments of the computer-implemented method, the intent taxonomy includes descriptions of the one or more user intent classes and examples associated with the one or more user intent classes.

In other embodiments, one or more computer storage media having computer-executable instructions embodied thereon that, when executed by one or more processors, cause the one or more processors to perform a method is provided. The method includes obtaining training data including data requests for information. The method further includes generating a model prompt to be input into a large language model, the model prompt including an instruction to generate an intent taxonomy, an indication of the training data to use for generating the intent taxonomy, and a taxonomy attribute desired to be used as criteria to generate a quality intent taxonomy. The method further includes obtaining, as output from the large language model, the intent taxonomy that includes one or more user intent classes. The method further includes using human input to validate or refine the intent taxonomy. The method further includes providing the intent taxonomy for subsequent use to identify, via the large language model, user intent associated with a new data request. In this way, embodiments, as described herein, enable efficient generation and use of intent taxonomies via use of trained machine learning models, such as a large language model, without requiring fine-tuning of the model. Further, in this way, embodiments, as described herein, a quality intent taxonomy is generated for use in accurately identifying user intent.

In any combination of the above embodiments of the media, the human input comprises recommendations for modifying the one or more user intent classes, descriptions associated with the one or more user intent classes, or examples associated with the one or more user intent classes.

In any combination of the above embodiments of the media, the human input comprises human-labeled user intent associated with data samples, and wherein the human-labeled user intent is compared with machine-labeled user intent generated via the large language model.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 9 in particular, an exemplary operating environment for implementing aspects of the technology described herein is shown and designated generally as computing device 900. Computing device 900 is just one example of a suitable computing environment and is not intended to suggest any limitation as to the scope of use or functionality of the technology described herein. Neither should the computing device 900 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 9, computing device 900 includes a bus 910 that directly or indirectly couples the following devices: memory 912, one or more processors 914, one or more presentation components 916, input/output (I/O) ports 918, I/O components 920, an illustrative power supply 922, and a radio(s) 924. Bus 910 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 9 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 9 and refer to “computer” or “computing device.”

Computing device 900 typically includes a variety of computer-readable media. Computer-readable media can be any available media that can be accessed by computing device 900 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 912 includes computer storage media in the form of volatile and/or nonvolatile memory. The memory 912 may be removable, non-removable, or a combination thereof. Exemplary memory includes solid-state memory, hard drives, and optical-disc drives. Computing device 900 includes one or more processors 914 that read data from various entities such as bus 910, memory 912, or I/O components 920. Presentation component(s) 916 present data indications to a user or other device. Exemplary presentation components 916 include a display device, speaker, printing component, and vibrating component. I/O port(s) 918 allow computing device 900 to be logically coupled to other devices including I/O components 920, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 914 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 900. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 900. The computing device 900 may be equipped with depth cameras, such as stereoscopic camera systems, infrared camera systems, RGB camera systems, and combinations of these, for gesture detection and recognition. Additionally, the computing device 900 may be equipped with accelerometers or gyroscopes that enable detection of motion. The output of the accelerometers or gyroscopes may be provided to the display of the computing device 900 to render immersive augmented reality or virtual reality.

A computing device may include radio(s) 924. The radio 924 transmits and receives radio communications. The computing device may be a wireless terminal adapted to receive communications and media over various wireless networks. Computing device 900 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS. GSM. TDMA, and 802.16 protocols.

The technology described herein has been described in relation to particular aspects, which are intended in all respects to be illustrative rather than restrictive.

What is claimed is:

1. A computing system comprising:
a processor; and
computer storage memory having computer-executable instructions stored thereon which, when executed by the processor, configure the computing system to perform operations comprising:
obtain training data including data requests for information;
generate a model prompt to be input into a large language model, the model prompt including an instruction to generate an intent taxonomy, an indication of the training data to use for generating the intent taxonomy, and a taxonomy attribute desired to be used as criteria to generate a quality intent taxonomy;
obtain, as output from the large language model, the intent taxonomy that includes one or more user intent classes;
analyze the intent taxonomy to determine whether the intent taxonomy is valid, wherein analyzing the intent taxonomy comprises:
generating, via the large language model, one or more user intent class labels for one or more samples, and
performing validation by prompting the large language model to analyze the one or more user intent class labels, and
wherein when the intent taxonomy is determined as valid, providing the intent taxonomy for use in identifying user intent, and when the intent taxonomy is determined as invalid, refining the intent taxonomy.

2. The computing system of claim 1, wherein the data requests include search queries or chat inquiries.

3. The computing system of claim 1, wherein the training data further includes data responses, user interactions, or a combination thereof.

4. The computing system of claim 1, wherein the taxonomy attribute comprises an accuracy criterion, a completeness criterion, a conciseness criterion, a clarity criterion, or a consistency criterion.

5. The computing system of claim 1, wherein the model prompt further includes an indication of a desired taxonomy structure.

6. The computing system of claim 5, wherein the desired taxonomy structure specifies information to provide in the intent taxonomy, a number of user intent classes, a number of examples to provide in association with each user intent class, a number of hierarchical levels in the intent taxonomy, or a combination thereof.

7. The computing system of claim 1, wherein the intent taxonomy includes a description associated with each user intent class of the one or more user intent classes and an example associated with each user intent class of the one or more user intent classes.

8. The computing system of claim 1, wherein refining the intent taxonomy includes updating the intent taxonomy with a new user intent class, a new example, or a new description or updating the intent taxonomy by removing a user intent class.

9. The computing system of claim 1, wherein analyzing the intent taxonomy to determine whether the intent taxonomy is valid comprises verifying comprehensiveness of the intent taxonomy by:
generating a prompt to annotate the one or more samples using the intent taxonomy;
providing the prompt as input to the large language model;
obtaining, as output, the one or more user intent class labels for the one or more samples; and
based on the one or more user intent class labels, determining a proportion of the one or more samples that have a user intent class label corresponding with a user intent class of the intent taxonomy.

10. The computing system of claim 1, wherein analyzing the intent taxonomy to determine whether the intent taxonomy is valid comprises verifying consistency of the intent taxonomy by:
generating a prompt to annotate the one or more samples using the intent taxonomy;
providing the prompt as input to the large language model;
obtaining, as output, the one or more user intent class labels for the one or more samples; and
based on the one or more user intent class labels, determining if the large language model consistently applied definitions associated with the one or more user intent classes.

11. The computing system of claim 1, wherein analyzing the intent taxonomy to determine whether the intent taxonomy is valid comprises verifying conciseness of the intent taxonomy by:
generating a prompt to annotate test samples using the intent taxonomy;
providing the prompt as input to the large language model;
obtaining, as output, user intent class labels for the test samples; and
based on the user intent class labels, determining if a threshold number of test samples have a user intent class label associated with each user intent class of the one or more user intent classes.

12. The computing system of claim 1, wherein analyzing the intent taxonomy to determine whether the intent taxonomy is valid comprises verifying accuracy of the intent taxonomy by:
generating a prompt to annotate test samples using the intent taxonomy;
providing the prompt as input to the large language model;
obtaining, as output, user intent class labels for the test samples;
comparing the user intent class labels output from the large language model to human-annotated user intent class labels for the test samples; and
based on the comparison, determining accuracy of the intent taxonomy.

13. The computing system of claim 12, wherein comparing the user intent class labels output from the large language model to the human-annotated user intent class labels comprises measuring an inter-coder reliability therebetween.

14. A computer-implemented method comprising:
generating a first model prompt to input into a large language model, the first model prompt including an instruction to generate an intent taxonomy and an indication of training data, including data requests, to use for generating the intent taxonomy;
obtaining, as output from the large language model, the intent taxonomy that includes one or more user intent classes based on the training data;
based on validating the intent taxonomy, storing the intent taxonomy for subsequent use in identifying user intent;
obtaining an intent identification request to identify user intent associated with a new data request;
generating a second model prompt to input into the large language model, the second model prompt including the intent taxonomy and an instruction to identify user intent associated with the new data request;
obtaining, as output from the large language model, a label of a user intent class associated with the new data request; and
providing the label of the user intent class associated with the new data request for display via a user interface or for analysis of the user intent corresponding with the new data request.

15. The method of claim 14, wherein validating the intent taxonomy includes using human-labeled user intent associated with data samples.

16. The method of claim 14 further comprising:
obtaining the new data request from a user device, the new data request comprising a search query or a chat inquiry; and
using the label of the user intent class associated with the new data request to generate a recommendation associated with the new data request to provide to the user device.

17. The method of claim 14, wherein the intent taxonomy includes descriptions of the one or more user intent classes and examples associated with the one or more user intent classes.

18. One or more computer storage media having computer-executable instructions embodied thereon that, when executed by one or more processors, cause the one or more processors to perform a method, the method comprising:
obtaining training data including data requests for information;
generating a model prompt to be input into a large language model, the model prompt including an instruction to generate an intent taxonomy, an indication of the training data to use for generating the intent taxonomy, and a taxonomy attribute desired to be used as criteria to generate a quality intent taxonomy;
obtaining, as output from the large language model, the intent taxonomy that includes one or more user intent classes;
using human input to validate or refine the intent taxonomy; and
providing the intent taxonomy for subsequent use to identify, via the large language model, user intent associated with a new data request.

19. The media of claim 16, wherein the human input comprises recommendations for modifying the one or more user intent classes, descriptions associated with the one or more user intent classes, or examples associated with the one or more user intent classes.

20. The media of claim 16, wherein the human input comprises human-labeled user intent associated with data samples, and wherein the human-labeled user intent is compared with machine-labeled user intent generated via the large language model.
